(19) United States
(12) Patent Application Publication
(10) Pub. No.: US 2005/0262014 A1
(43) Pub. Date: Nov. 24, 2005

(54) Relative valuation system for measuring the relative values, relative risks, and financial performance of corporate enterprises

(76) Inventor: Steven W. Fickes, Bethesda, MD (US)

Correspondence Address: JACOBSON HOLMAN PLLC, 400 SEVENTH STREET N.W., SUITE 600, WASHINGTON, DC, 20004, US

(21) Appl. No.: 10/387,412

(22) Filed: Mar. 14, 2003

Related U.S. Application Data
(60) Provisional application No. 60/364,328, filed on Mar. 15, 2002.

(51) Int. Cl. G06F 17/60

(52) U.S. Cl. 705/38

(57) ABSTRACT

A system and method for defining the value of a corporation by its categories of values, and determining the risk profile of the corporation by the relationship between the categories of value, termed the “Risk Signatures.” The system provides for the determination of the “Relative Values” of corporate enterprises, with the capability of dynamically monitoring and measuring the financial performance of an enterprise through the use of artificial intelligence and data mining techniques.

This is a complete utility application entitled to the priority and claiming the benefit of U.S. provisional application Ser. No. 60/364,328 filed Mar. 15, 2002.

### COPYRIGHT NOTICE

This document contains material, which is subject to copyright protection. The applicant has no objection to the facsimile reproduction of this patent document, as it appears in the U.S. Patent and Trademark Office (PTO) patent file or records or in any publication by the PTO or counterpart foreign or international instrument-alies. The applicant otherwise reserves all copyright rights whatsoever.

### FIELD OF THE INVENTION

This invention relates to systems and methods for the determination of the relative values and relative shareholder risks of corporate enterprises. “Relative” in this document means compared to peers within an industry group utilizing consistently applied and derived assumptions gained from historical data. More particularly, the present invention has the ability to value any corporate enterprise, on a relative basis, using publicly derived data together with consistently applied formulas and methods. Still more particularly, the system has the capability to allow a user to perform comparative analysis of corporations against selected peers and industry standards. Even more particularly, the systems and methods utilized allows corporations to translate strategic goals into financial targets and to measure the drivers behind shareholder value creation.

### I. DESCRIPTION OF THE PRIOR ART

Over the past decade corporations world-wide have grown reliant on ready access to the public equity markets. During this same period, investors have increasingly viewed the public equity markets as a safe, dependable alternative to other more traditional investments. While today the reliance on public equity markets is likely at an all time high, the clarity and certainty of the reported income results and balance sheets for many corporations and industries is not. Due to the increased complexity of generally accepted accounting principles (GAAP), the globalization of many businesses, the use of one time accounting charges, the practice of reporting of Pro Forma results and multi-level regulatory and tax requirements imposed on many industries, it has become virtually impossible for outsiders to assess the value of corporations based on reported GAAP income or GAAP equity.

### A. Current Valuation Methods

Probably the most common measure of the value of a corporation has been a price to earnings multiple applied to reported GAAP earnings. This has been a convenient measure since typically, although perhaps incorrectly, GAAP earnings are viewed as the amount of money, which a corporation could theoretically pay out to shareholders as dividends or use to repay debt. The major disadvantage in relying upon GAAP earnings as a measure of the value of a corporation is that GAAP accounting has tended to become more concerned with managing the “timing” of when a corporation may report earnings not necessarily when those “earnings” are in fact available to the corporation in the form of cash. Increasingly, there seems to be a disconnect between the GAAP valuation of companies and their true values. When this happens, as it has many times in the past, a corporation can report respectable GAAP earnings yet very quickly become financially impaired.

The disconnect between reported GAAP earnings and true values can mislead investors into believing companies with equal GAAP earnings are comparable, when in fact they may have radically different risk profiles. Take as an example, two life insurance companies which issue identical life insurance products, with the only exception being that Company A pays its agent a commission rate as a level percentage of premiums as they are earned, while Company B pays its agent a single lump sum commission rate, equivalent to the other agents commission on a discounted basis. A comparison of the two commission schedules is shown in FIGS. 1 and 2.

In this example, Company B, which paid its all agent all of the commission up front will report higher GAAP earnings on the transaction, than Company A which paid its agent as premiums were earned. The intent of GAAP, is to make both companies report identical earnings. Therefore, since the Company B, paid its cash out up front it has less investment income and must report more income form the transaction, in order for its total GAAP income to be equal to the total GAAP income of the Company A, which paid out less and retained its cash. The GAAP income, which would be reported from each of these respective transactions, is shown below in Table 1.

TABLE 1

| | | | | |
|---|---|---|---|---|
| Year 1 | Year 2 | Year 3 | Year 4 | Year 5 |

Company A
GAAP Income from Transaction

| | | | | | |
|---|---|---|---|---|---|
| Premiums | $100.00 | $100.00 | $100.00 | $100.00 | $100.00 |
| Commissions | 25.00 | 25.00 | 25.00 | 25.00 | 25.00 |
| Expenses | 65.00 | 65.00 | 65.00 | 65.00 | 65.00 |
| GAAP Income | $10.00 | $10.00 | $10.00 | $10.00 | $10.00 |

Company B
GAAP Income from Transaction

| | | | | | |
|---|---|---|---|---|---|
| Premiums | $100.00 | $100.00 | $100.00 | $100.00 | $100.00 |
| Commissions | 109.68 | 0 | 0 | 0 | 0 |
| Deferred Costs | (90.61) | 20.41 | 21.84 | 23.36 | 25.00 |
| Expenses | 65.00 | 65.00 | 65.00 | 65.00 | 65.00 |
| GAAP Income | $15.93 | $14.59 | $13.16 | $11.64 | $10.00 |
| Cumulative Additional | $5.93 | $10.52 | $13.68 | $15.32 | $15.32 |
| GAAP Income | | | | | |

In the example just discussed the two Companies would report equal total GAAP earnings, yet Company A, would have all of its earnings, cash in the bank, while Company B has substantially less cash, and the return of that cash is subject to future contingencies or risk. By using GAAP earnings as a determinate of value, the relative risk associated with such value will likely be overlooked. The total reported GAAP earnings for these two illustrative companies are shown below in Table 2.

TABLE 2
Company A
Total Reported GAAP Income

| | | | | | |
|---|---|---|---|---|---|
| Income from Transaction | $10.00 | $10.00 | $10.00 | $10.00 | $10.00 |
| Investment Income | .70 | 1.45 | 2.24 | 3.12 | 4.02 |
| on Cash | | | | | |
| GAAP Income | $10.70 | $11.45 | $12.24 | $13.12 | $14.02 |

Company B
Total Reported GAAP Income

| | | | | | |
|---|---|---|---|---|---|
| Income fromTransaction | $15.93 | $14.59 | $13.16 | $11.64 | $10.00 |
| Investment Income | (5.23) | (3.14) | (.90) | 1.47 | 4.02 |
| on Cash | | | | | |
| GAAP Income | $10.70 | $11.45 | $12.24 | $13.12 | $14.02 |

In addition to obscuring the risk profile of companies, GAAP accounting can at times produce what would appear to be intuitively incorrect results. Take as an example two companies which are identical in every past and future respect, with the only exception being that one of the companies is purchased at a higher price than the other. From that point forward, the company which was purchased at the higher price would be required by GAAP accounting to report lower GAAP earnings than its identical twin even though the two companies have identical revenues and identical operating costs. There is no logical rationale why companies with identical revenues and costs should have anything other than identical earnings.

Another major disadvantage to relying on GAAP earnings as a measure of value is that GAAP earnings can vary significantly for identical companies depending on the objectiveness of management in establishing assumptions. The ability of management to establish intangible assets, defer or capitalize costs and expenditures, and set the assumptions to be used in determining the amortization thereof, seems to be a system designed to invite mischief by deferring problems into the future or bringing optimism forward.

Even with the rules of GAAP accounting favoring management's ability to present a glossier picture than reality, corporations for the last several years have added one time write-offs as a means of further improving future GAAP earnings. Write-offs are generally viewed as positive, since write-offs typically amount to no more than the recycling of past GAAP earnings into future GAAP earnings, thereby increasing the GAAP valuation. While a write-off may improve future GAAP earnings it seems counterintuitive that it would actually increase the value of an enterprise.

A more recent fad that purports to aid investors in understanding the performance and values of a corporation has been the creation of Pro Forma GAAP earnings. Pro Forma earnings allow management to lead investors to ignore selected items in arriving at the desired earnings upon which value (in management's glossier view) should be based. The use of Pro Forma accounting seems to call into question the very underlying basis of a companies reported GAAP income.

Aside from the issue of the appropriateness of GAAP earnings as the basis upon which a price to earnings multiple should be applied, there are questions as to the appropriateness of the multiples which are used. Often stock analysts will argue that even if a multiple declines significantly, if a corporations earning grow fast enough the rate of return an investor can earn over a short time horizon can be very attractive. In such analysis the fact that the beginning multiple has no legitimate basis is overlooked. Many times the multiple is based on a combination of speculation and peer comparisons, where everyone assumes someone else correctly knows what they are doing. An example of type of rate of return analysis is shown in FIG. 3.

Situations where price earning multiples are based on peer comparisons together with the assumption that there is a valid basis for the peer multiples has been at the root of many recent speculative valuation debacles.

In addition to GAAP earnings and price-earnings multiples being used as the basis for the valuation of corporations, multiples of GAAP equity, or book values have also been frequently used. One of the many dangers in this practice is that GAAP pre-supposes that the price paid for many assets is the correct value of that asset for balance sheet purposes. For example, if a corporation acquires another corporation and pays in excess of the acquired corporation's net worth the excess is booked as goodwill, an asset. Recent changes in accounting standards now require a write-off of goodwill when the market value of a corporation's stock reflects the fact that the investing public is not valuing “goodwill”. There is something intuitively wrong with basing valuations on a multiple of balance sheet equity, when such equity can be adjusted downward in such a manner.

Some industries routinely capitalize, as an asset, money which has been spent. Such assets, following accounting rules are accreted with interest and then amortized, giving them the appearance of being real when in fact, like goodwill, they are non-investable, non-spendable accounting entries. To base valuations of corporations on multiples of GAAP equity which includes assets that are no more than accounting entries seem to reward the creation and inflation of such assets.

Due to questions regarding the quality of reported earnings, and because the proliferation of the rules for the determination of GAAP income and balance sheet items, there has also been an accompanying increase in amount of disclosure data companies produce for prospective investors. In a recent Initial Public Offering, the company's prospectus exceeded 500 pages. Due to widespread accounting problems with derivative investments, there have been recent proposals that companies should be required to disclose the assumptions they used in determining the value of derivative investments. The result of the requirements to disclose has been that disclosures have become so voluminous and technical as to be meaningless.

Overall, GAAP has not been a good prognosticator of value and current accounting disclosure practices, although voluminous, make the assessment of risk impracticable if not impossible. Current accounting practices and disclosures do not give investors the tools they need to ascertain the values of corporations and the associated relative risks.

### B. The Ability to Make Informed Decisions

Over the past decade the quantity of data available to corporate decision-makers and investors has increased exponentially, and continues to do so at an accelerating rate. The development of tools to synthesize such data into meaningful information and knowledge, however, has not kept pace.

Numerous new factors are now influencing how corporations control operations, report financial health, view the macro-universe, and respond to change. The landscape viewed by today's corporate leaders has violently shifted from the stable, predictable and comfortable environment of the last decade to one which is technology driven, increasingly competitive, shareholder empowered, volatile, brutally scrutinized with the benefit of 20/20 hindsight vision, demanding of clear and understandable reporting, and expectant of instant response.

Throughout the course of each day every decision-maker may consciously make a few decisions while unknowingly making thousands. Most of these decisions are made in absentia—they are decisions and actions that take place by default, or because the decision maker did not have access to information.

Simple but critical business maxims—any decision not made is a decision made; and decisions made in the absence of good information are “chance decisions”. There are numerous examples of such decisions, which are made currently made each day by corporations, which impact shareholder value. The following are examples:

Personnel decisions—A decision to not terminate someone today is a decision to retain them for another day. Even when such decisions are made, they tend to be made based on impressions, comfort levels and other intuitive feelings as opposed to analytical knowledge such as performance verses peers.

Personnel issues verses Strategic issues—Even when performance can be properly measured, if it viewed in isolation it may be meaningless. Currently, corporations do not have the ability to judge whether below or above average performance is the result of a deficient or superior execution or was it the result of a deficient or superior strategy.

Corporate Resources—Many areas where a company could improve performance they do so only if it is intuitively obvious. The less obvious areas are given limited resources, human and capital. Corporations currently do not have the ability to easily assess where resources should be focused in order to optimize the return on the investment of resources.

Alternatives—Business opportunities, such as acquisition targets, currently are presented, analyzed and determined to be beneficial to a company's future only when target is known to be available. Currently, only a few corporations have the capability of comparing how a presented opportunity compares to the universe of alternatives, especially those which have not been presented.

Strengths and weaknesses—Most companies have a perception of what are their strengths and weaknesses at a relative high level. Even when these perceptions prove correct, the knowledge is imperfect without knowing the comparative strengths and weakness of competitors.

Value Creation—For most corporations linear decisions can be made with an intuitive feel as to the foreseeable outcome. Multidimensional decisions, such as “what will be the impact of a change in sales practices which increase costs but also increase sales,” are not always as intuitive. The inability to correctly access multidimensional decisions leads many corporations to make incorrect decisions which ultimately have a negative impact on shareholder value.

Financial tools which utilize the data that is currently available to perform financial forecasts, evaluate, assess, test and finalize decisions within minutes are presently not available to corporations or their investors. What tools are available often result in the divergence of knowledge rather than the convergence of knowledge.

### C. Translation of Strategic Goals into Financial Targets

The translation of the strategic goals of a company into financial targets that then can be incorporated into the business process is a difficult task and one that very few corporations manage to achieve. For example, many companies produce strategic plans and goals that respond to the changes that have taken place in the external business environment. These strategic goals then are expressed in terms of financial targets, but rarely do these same companies change the pricing of their products to reflect the changes made to the financial targets. As a consequence, the financial results of the company cannot reflect its strategic goals.

Clearly, if the strategic goals are to be achieved, there must exist a link between the financial targets and the financial results. Fundamental to being able to achieve the financial targets is the ability to measure whether or not they have been met. Very few corporations today have integrated links between their financial management forecasting systems, and the systems that report actual results.

Quite often, corporations establish strategic goals throughout their organization which, if the outcome of achieving all such goals were viewed, it would also be known that the strategic goals are mutually exclusive of the desired financial goals of the corporation. The lack of the ability for corporations to link strategic goals, financial goals, and actual financial results is the result of financial forecasting and reporting systems which are non-integrated and incapable of instantaneous feedback.

### II. SUMMARY OF INVENTION

The Relative Value Method of reporting measures the financial performance of a corporation by the increase (or decrease) in the value of the company from one period to the next. The value of a corporation is defined as the present value of the expected stream of future cash flows, which are expected to be generated from its operations in all future years. This present value is intended to reflect future values discounted at a risk adjusted discount rates.

The rationale for the use of a Relative Value Method is that over time the market value of a corporation's share price should be a reflection of the underlying value of the corporation, which is its ability to produce cash.

While the Relative Value Method of measuring financial performance can provide insight into the performance of individual companies, the most significant advantage to be gained by the Relative Value Method is the ability to compare the Relative Values and changes in Relative Values for all companies within an industry or sector.

The Relative Valuation System is a set of financial tools which utilizes databases of financial information to perform financial forecasts for all companies in an industry or sector. In doing this, the Relative Valuation System can provide vast quantities of useful information that can enable decision makers to easily and quickly evaluate, assess, test and finalize informed decisions. The concept of transforming Data-to-Knowledge is central. The Relative Valuation System produces answers to “what if” questions for corporate decision-makers within minutes as opposed to traditional timeframes of days or weeks. Board meetings can have real-time discussions and decision-making sessions which are not subject to delays which may move the answer and decision beyond the realm of usefulness.

The Relative Valuation System addresses a very basic need of industry at the highest level—making smarter decisions that maximize shareholder value.

The Relative Valuation System provides measurements tools, with which performance can be judged, including the change in the Relative Values of all companies within a sector or industry on a consistent basis.

In addition to providing performance measures, The Relative Valuation System provides comparative analysis with each performance measure to enable the user to also understand the “why” of performance.

The Relative Valuation System allows the user to look forward in time to quantify the impact individual decisions will have on the earnings of a company and more importantly the value. For an industry, the Relative Valuation System can both identify and analyze comparable companies to any selected target or peer standards.

The Relative Valuation System allows the user to compare and assess the strengths and weakness of any company against any selected peer or competitor groupings. By measuring the change in the relative value of an entire corporation caused by a single decision with multiple outcomes, the Relative Valuation System can give the decision-maker the appropriate knowledge upon which to make such a decision.

These together with other objects and advantages which will become subsequently apparent reside in the details of construction and operation as more fully hereinafter described, reference being had to the accompanying drawings forming a part hereof.

### III. BRIEF DESCRIPTION OF THE DRAWINGS

FIG. 1 is a graph of a commission schedule according to the prior art;

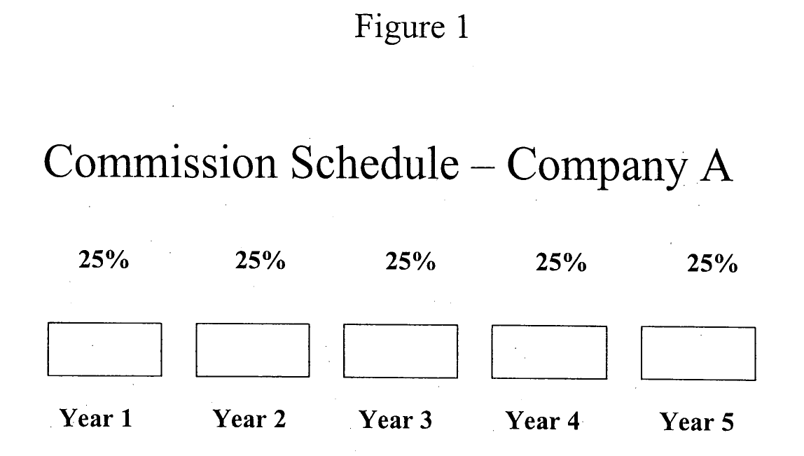

FIG. 2 is a graph of an alternate commission schedule according to the prior art;

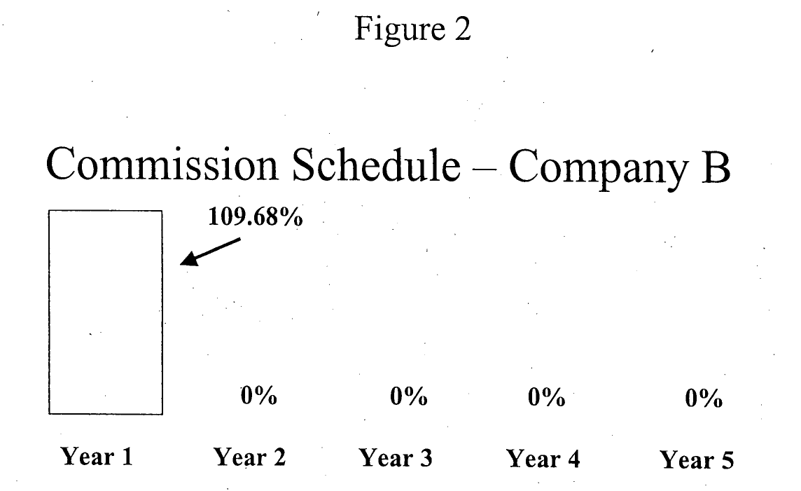

FIG. 3 is a comparative graph of an investor rate of return analysis according to the prior art;

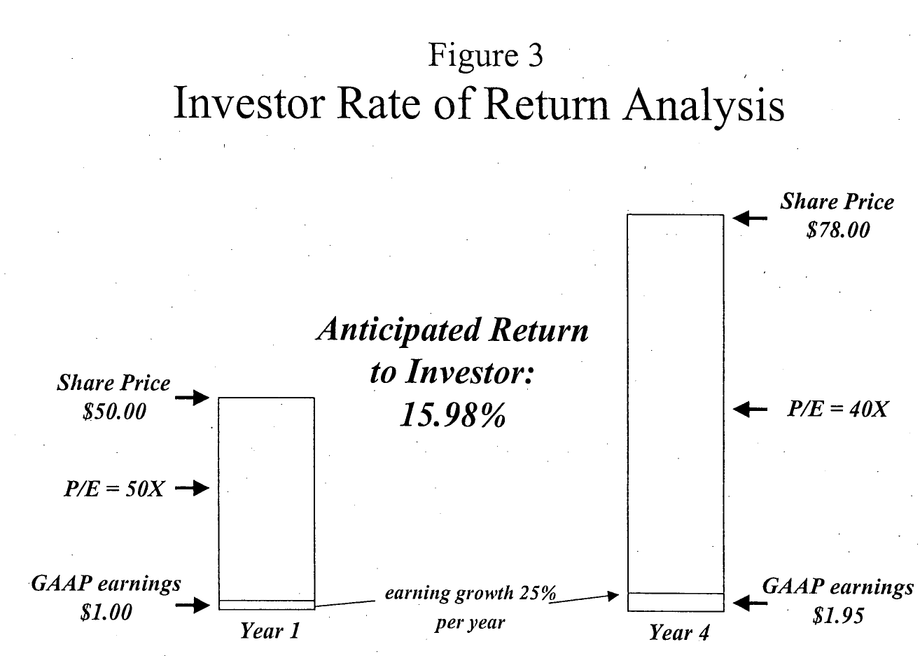

FIG. 4 depicts representative risk signatures for four companies using the Relative Value Method according to the present invention;

FIG. 5 illustrates movement of values modifying one of the risk signatures of FIG. 4;

FIG. 6 illustrates movement of values modifying one of the risk signatures of FIG. 4;

FIG. 7 illustrates movement of values modifying one of the risk signatures of FIG. 4;

FIG. 8 is a block diagram of the modules of the Relative Value System according to the present invention;

FIG. 8A is a block diagram depicting a configuration of the Relative Value System with a distributed computer network in accordance with the present invention;

FIG. 9 is a block and flow diagram of module one of the Relative Value System as set forth in FIG. 8;

FIG. 10 is a block and flow diagram of module two of the Relative Value System as set forth in FIG. 8;

FIG. 11 is a block and flow diagram of module three of the Relative Value System as set forth in FIG. 8;

FIG. 12 is a block and flow diagram of module four of the Relative Value System as set forth in FIG. 8;

FIG. 13 is a block and flow diagram of module five of the Relative Value System as set forth in FIG. 8;

FIG. 14 is a block and flow diagram of module six of the Relative Value System as set forth in FIG. 8;

FIG. 15 illustrates a control panel screen within the Relative Value System according to the present invention;

FIG. 16 illustrates a display screen for company selection and modification using the Relative Value System according to the present invention;

FIG. 17 illustrates a display screen submenu for report selection using the Relative Value System according to the present invention;

FIG. 18 illustrates sample selection criteria for the intelligent peer group builder within the Relative Value System according to the present invention;

FIG. 19 illustrates a representative display screen allowing the user to edit default assumptions when performing interactive dynamic modeling in accordance with the present invention;

FIG. 20 is a representative display screen enabling the user to view of the results of the edited assumptions entered through the screen of FIG. 19; and

FIG. 21 is a display screen illustrating representative selection criteria for the relative value peer group builder according to the present invention.

### IV. DETAILED DESCRIPTION OF PREFERRED EMBODIMENTS

In describing preferred embodiments of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

### A. Relative Value Method

With the Relative Value Method, the value of a corporation at anytime can be defined by the following four

Categories of value:

Category I—Current Realizable Value
Category II—Value of Existing Enterprise
Category III—Infrastructure Value
Category IV—Venture Value

The Relative Value Method generally concerns itself with the change in the first three Categories of values. For values to be recognized within the first three Categories of value, they must be demonstrable based on actual past performance. Items, which can not be valued, based on past performance, can still be included in the overall value of a corporation but they are included in Category IV, as venture values.

With the Relative Value Method an enterprise can be judged by measuring all of the Categories of values in the aggregate, and the risk associated with an enterprise's value can be gauged by the relationship between the various Categories of value

### Category I—Current Realizable Value

The first Category of value is the assumed liquidity value of corporation. This is the value a corporation has on hand without regard to future events. In other words, cash and marketable securities.

A good proxy for this value might be a companies adjusted net worth, determined without regard to intangible assets such as goodwill, or non-liquid assets such as inventories, plants and equipment.

With regulated industries where there are regulatory prohibitions that prevent even the net worth of a company from being immediately available, there should be adjustments to the Category I value, by means of a cost of capital charge.

### Category II—Value of Existing Business

The second Category of value, used in determining the Relative Value, is the present value of future cash flows which are expected to be derived from the existing customer base or business. A telecommunication company, for example, would have a customer base, which without any further marketing expenses should continue to generate revenues although on a declining basis. The profit margins on the existing customer base will likely be greater than the profit margins, if any, from new customers. This steam of net cash flows should also be more predictable than potential net cash flows from future new customers.

By projecting the expected future revenue and expected future expenses associated with maintaining that revenue, from an existing customer base, the Category II value can be determined by discounting the expected cash flows, back to the measurement date, at a risk adjusted rate of interest.

### Category III—Infrastructure Value

The third Category of value is the discounted value of expected future cash flows from business which can reasonably be expected to be produced in future years, from new sales. The costs associated with new sales and the expected level of new sales can generally be determined from the historical financials. Unlike the existing customer base, the net cash flows from future new customers are less predictable, and therefore the discounted value of future expected net cash flows should be determined using a higher risk adjusted discount rate.

To the extent future new sales are expected to exceed those which could reasonably be demonstrated from the historical financials the excess net cash flows which could be expected from such future new sales would be discounted, using a risk adjusted discount rate, and included as a Category IV value.

### Category IV—Venture Value

A fourth Category of value, the present value of cash flows from businesses or lines of business with no demonstrable financial history, should be regarded as venture value. This category of value would be regarded as analogous to venture capital investments.

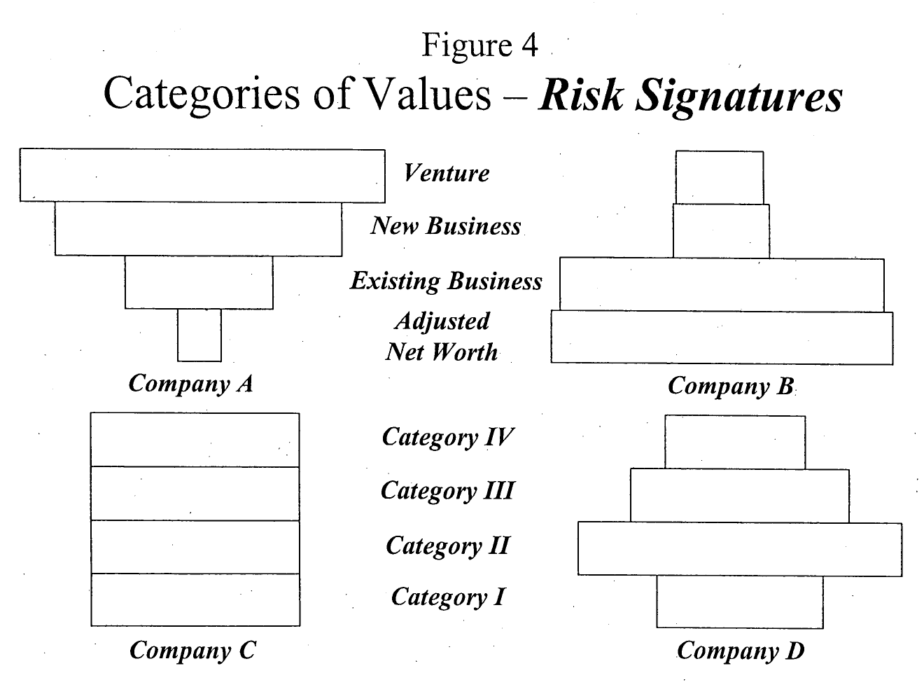

For illustrative purposes within FIG. 4, the “Risk Signatures, ” for four hypothetical companies are shown. The total values for all four companies in this Figure are equal. As can be seen from the Risk Signature representing Company A, the company has a substantial proportion of its value represented by Category IV, venture value. This picture would be even more pronounce were in not for higher discount rates being used for each respectively higher category of value. Company A is clearly seen, by its Risk Signature, to be a company where most its value would be equivalent to venture capital type investments. This company will either pay very high returns if it properly executes, or face potential failure.

Company B, as also seen in FIG. 4, is the antithesis of Company A. The majority of it value is in net worth or its current customer base. The Risk Signature of Company B, would instantly tell an observer that Company B is very risk adverse and will likely have lower yet secure returns for an investor.

Companies C and D, as shown in FIG. 4, represent companies which have much more balanced risk profiles. The Risk Signatures, which are a unique by-product of the Relative Value Method, allows even a non-skilled practitioner of the art of corporate risk measurement to quickly and intuitively comprehend the risk profile of a company.

### Movement of Value between Categories

With the Relative Value Method, the operations of a corporation may result in the movement of values from one Category of value to another with no net change in the overall Relative Value of the corporation. For example, an Internet Service Provider might spend an additional $1 million on marketing during a year, which would cause new sales to increase by 10% for the year compared to a historical rate of say 4%. The expenditure of the $1 million would have had an immediate impact of decreasing the corporation's Category I value, yet would have also resulted in an increase in the Category II value, because of the additional new sales which occurred, assuming existing customers generate positive cash flows, and could also have increased the Category III values, if the net increased sales revenues anticipated going forward exceeds the projected increased sales costs.

A second example, using the Relative Value Method, would be one where a corporation announces a one-time charge for a restructuring to improve future costs. While GAAP accounting would allow for the immediate recognition of such a charge which would then impact the future GAAP reported earnings, the Relative Value Method would not.

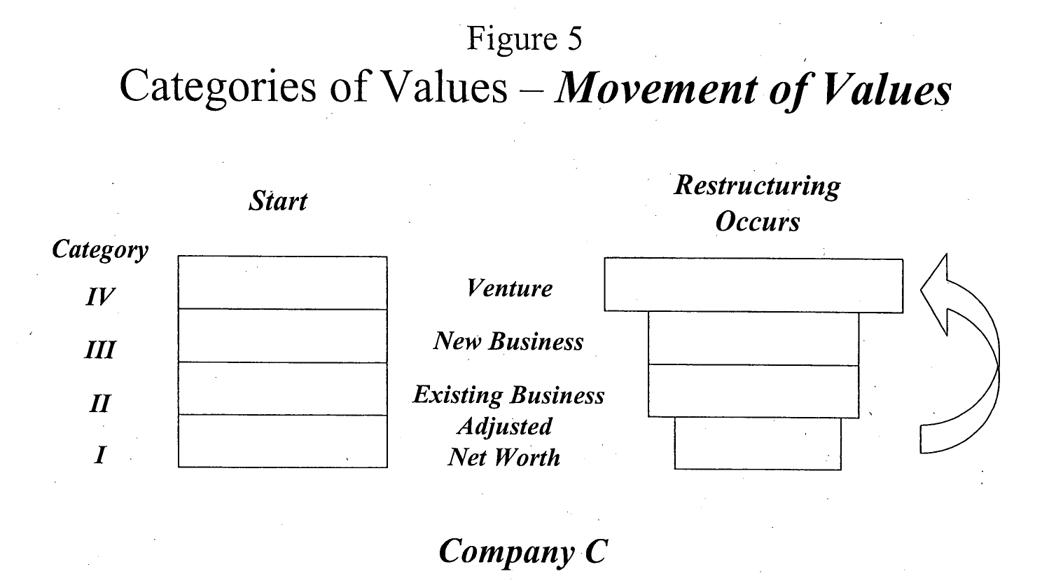

As shown in FIG. 5, we have used Company C from the previous example to illustrate the movement of value under the Relative Value Method. FIG. 5 shows the impact on Company C's values when the severance costs were actually incurred. The severance costs would reduce the Category I value. If it could reasonably be expected that the cost reductions would improve future margins, the corporation could show an increase in the Category IV value, as is also shown in FIG. 5.

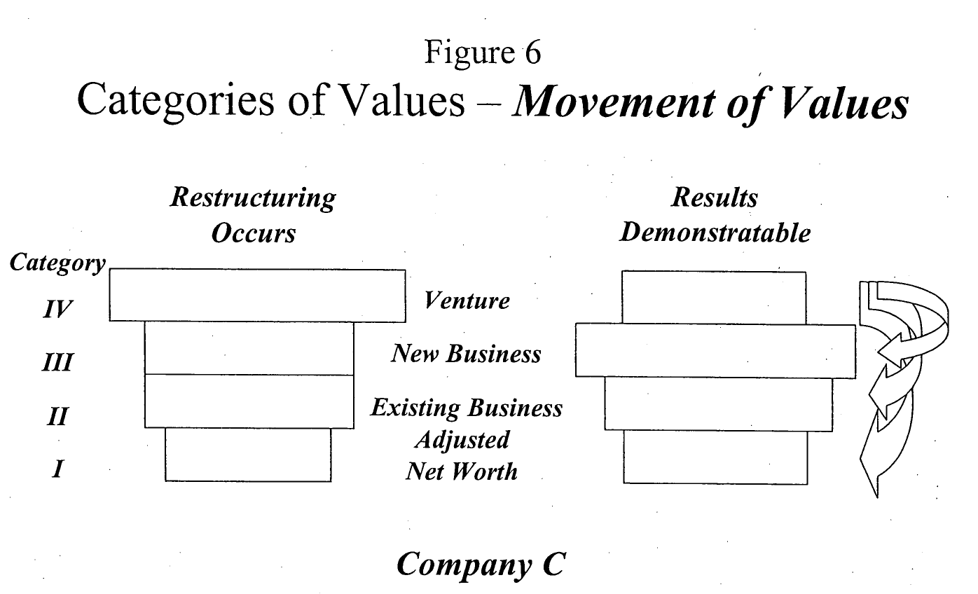

In this example, the Relative Value Method reflects what has actually happened. Corporate value that is very secure, cash on hand, has left the corporation and been replaced with value to be earned at some point in the future, with no guarantee or history to demonstrate that it will materialize. As time progresses and the corporation's expense reductions are actually realized, the Category IV value will become Category II and III values, reflecting the higher margins on existing customers and future new sales due to lower costs. This movement in value is shown in FIG. 6.

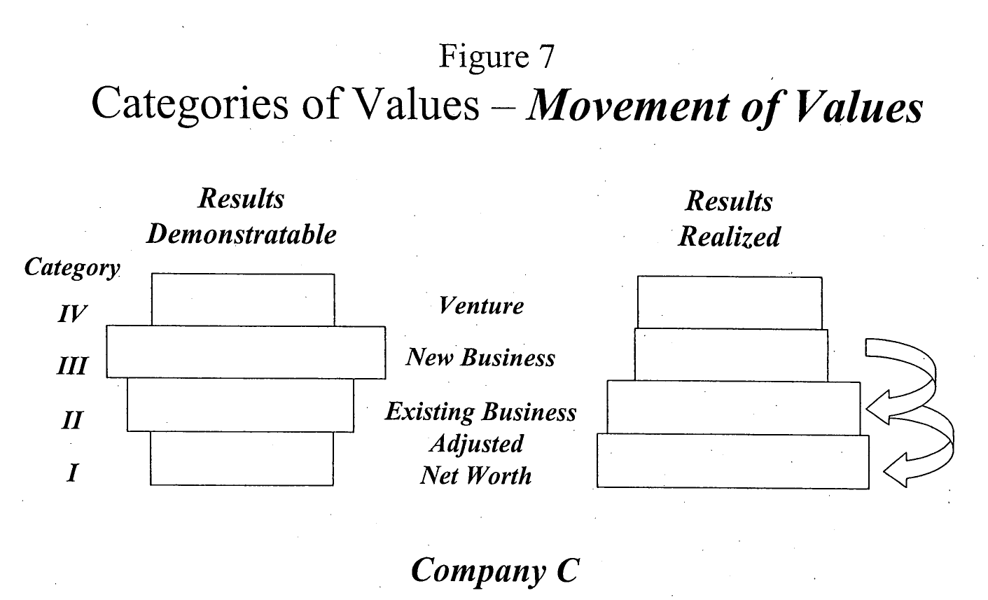

Ultimately, as the saving from the restructuring materializes, it results in increased cash flow and an increase in the Category I value. This movement of value is shown in FIG. 7. These examples help to illustrate how the Relative Value Method reflects the risk profile of a company in combination with value realization.

### Changes in Relative Values

The major advantage the Relative Value Method for investors and managements, is that it comes as close as possible to being a single focal point for decision making. When someone asks what the weather is, they likely don't want to known the barometric pressure, the pattern of the jet stream or the movement of various fronts. They want to know that it is 72 degrees and sunny!

At the very top, Relative Value Method focuses on the increase in the value of the corporation and describes the relative risk. A corporation's collective objective should be on increasing the value of the enterprise while maintaining a balance in the enterprise risk profile. The Relative Value Method tells management and shareholders by how much the enterprise's value has grown and the Risk Signature conveys instantly whether there has been a shift in the enterprise's risk profile.

This singular focus brought about by the Relative Value Method, can easily be translated, through the use of the Relative Value Models, into individual goals suitable for line and middle management. For example, the marketing officer's goal may be the 5% increase in new sales and a decrease in sales expense of 2%, which would both be necessary in order to achieve the overall corporate goal of increasing the value of the corporation. In the aggregate, if all individual goals and targets are achieved, the overall strategic goal will be achieved.

### Credibility Factors

The Relative Value Method also lends itself to the development of creditability factors. In the determination of the Category II, III and IV values, net projected cash flows were developed. At the end of each year the ratio of the actual cash flows to expected cash flows can be calculated for each Category of value. This ratio of actual to expected cash flow, represents the credibility factor. A credibility factor close to 100% would be a good indicator of the credibility of the values presented. A low ratio would tend to indicate that the forecasts used in determining values lack credibility.

### Volatility Factors

Another useful measure can be developed through the use of the Relative Value Method is a “volatility” factor. While two separate corporations can have identical values, if the project future net cash flows for one corporation were greater but skewed further out into the future they will be subject to a greater number of future contingencies and therefore potentially more risk. The volatility factor is the measurement of the rate of change in a Categories value resulting from a change in the discount rate. Therefore, a higher volatility factor will indicate a longer duration of a Category of value, and greater potential risk.

### B. Relative Valuation System

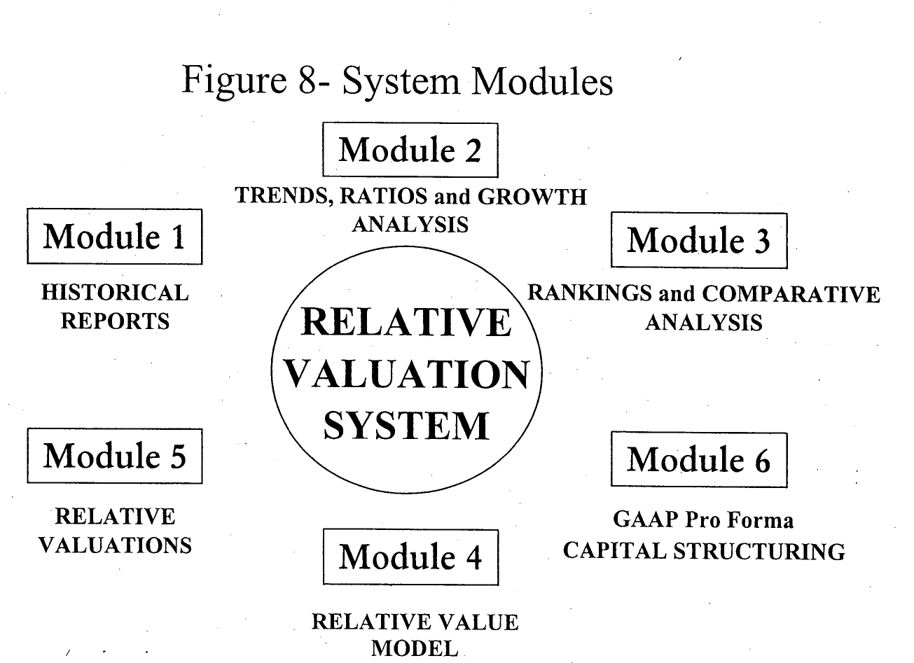

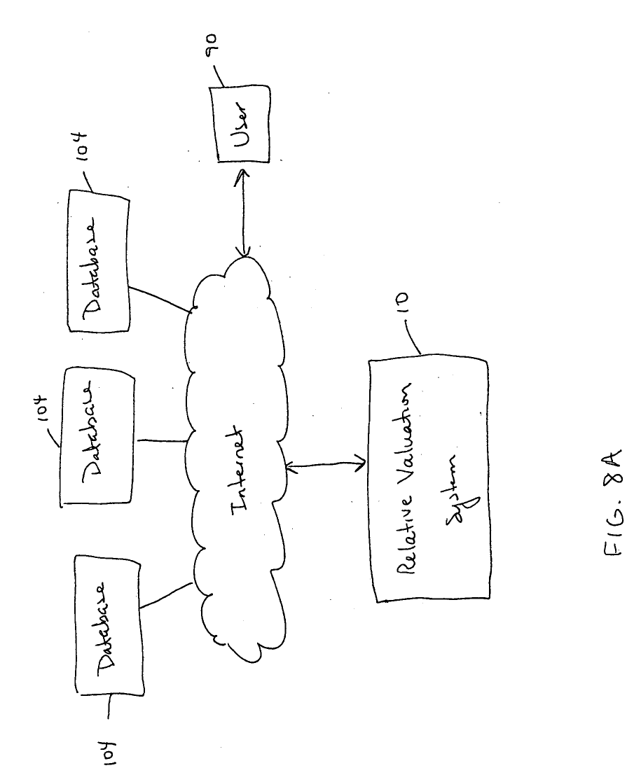

The Relative Valuation System is a set of financial tools organized as modules which utilize databases of financial information to perform financial forecasts for all companies in an industry or sector in a matter of minutes. As shown in FIG. 8A, the Relative Valuation System 10 is arranged on a server connected to a distributed computer network, such as the Internet. Through the distributed computer network, the system access a plurality of publicly available financial databases 104. In response to a request from a user 90, data is mined from these databases and used to generate a variety of reports.

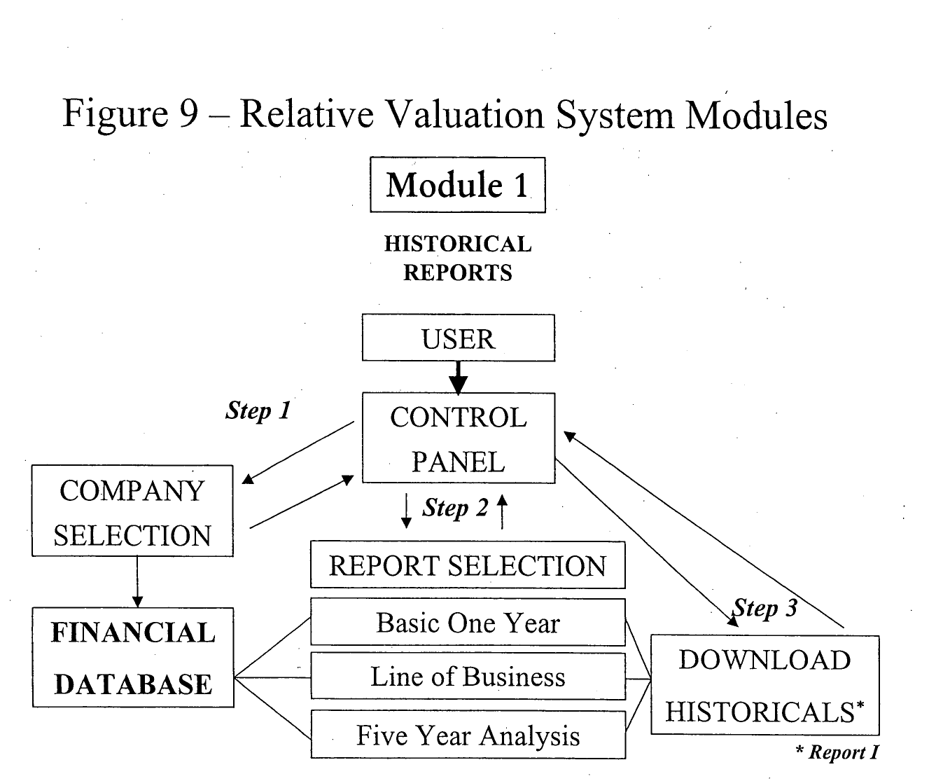

As shown in FIG. 8, the Relative Valuation System is viewed best by looking individually at the six operating modules that comprise the complete system. These modules include the Historical Reports module, the Trends, Ratios and Growth Analysis Module, the Rankings and Comparative Analysis Module, the Relative Value Model Module, Relative Valuations Module, and the GAAP Pro Forma Capital Restructuring Module. FIGS. 9-14 are diagrams depicting the various components of the system and the individual operating modules.

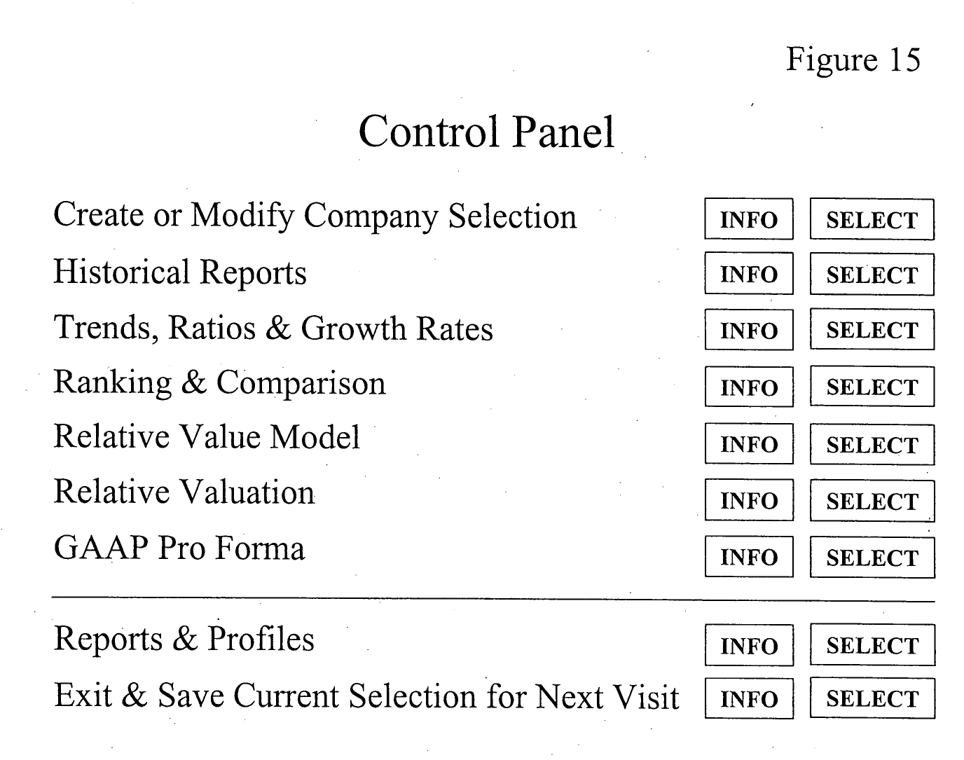

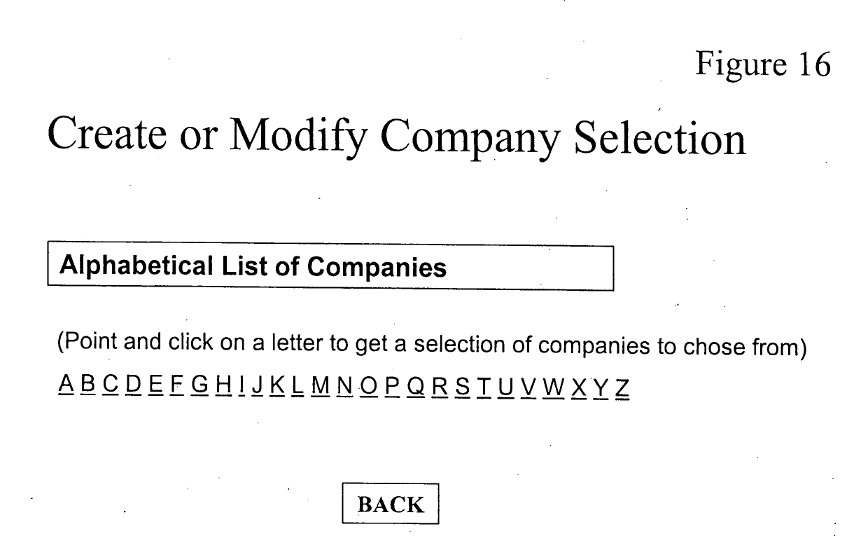

The Relative Valuation System allows the user to choose from any of the companies within the database. From a Control Panel, similar to that which is shown in FIG. 15, the user would click on the SELECT button next to Create or Modify Company Selection item. The user can then choose either to work with an individual company or a group of financially related companies. The user makes the election by choosing from a menu either “company” or “group of companies”, as shown in FIG. 16.

To select a company or group the name or a part of the name is typed to help the system to identify a list of possible “hits” for the user. When the user sees the company name that the users wants to include in the analysis, the user just points and clicks on its name and then repeat the process until the user has added all the companies that the user wants. Alternatively, the user could have searched for all the companies with beginning with a single letter such as “j”, and accomplished the same goal.

When the user completes the list of companies to analyze, the user would return to the master control panel to begin to select the other aspects of the system to be used.

### Historical Reports

Within the Historical Reports module of the system, FIG. 9, there are three very different types of reporting and analysis. Although three sub-reporting areas focus on data from income statements, balance sheets, and summary of operations from publicly available data, the perspectives of the three reports are different. The first set of reports looks at simply one year income and balance sheet analysis, the second looks at historical financials by major line of business and individual lines of business levels, and the third looks at five year analysis and trend formation.

Any of the historical reports can be downloaded to the user in “pdf” format so that the user can print them on any printer and obtain the same visual results. This set of historical reporting tools enables a user to view the selected company and its peers as part of an industry and not only as a standalone entity.

Sample out from the Historical Reports module is shown below in Table 3.

TABLE 3
Historical Report

| | | | | |
|---|---|---|---|---|
| Year t − 5 | Year t − 4 | Year t − 3 | Year t − 2 | Year t − 1 |

Income Statement

| | | | | | |
|---|---|---|---|---|---|
| INCOME STATEMENTS | | | | | |
| Revenues | 8,317,511 | 8,186,794 | 7,529,646 | 9,154,184 | 10,007,370 |
| Net Investment Income | 2,678,475 | 2,803,114 | 2,856,033 | 2,956,192 | 3,033,441 |
| Other Income | 54,120 | 37,915 | 26,317 | 52,355 | −2,463 |
| Total Revenue | $11,050,106 | $11,027,823 | $10,411,996 | $12,162,731 | $13,038,348 |
| Cost of Goods and Services | 2,455,478 | 2,632,439 | 2,503,293 | 2,481,543 | 2,618,822 |
| Cost of Other Services | 6,367,280 | 6,669,026 | 7,367,120 | 7,707,269 | 8,501,782 |
| Cost of Sales | 207,783 | 250,341 | 239,372 | 240,696 | 248,873 |
| General Administrative Expenses | 603,209 | 608,351 | 565,354 | 628,670 | 748,576 |
| Other disbursements | (76,616) | 145,364 | (227,854) | 257,073 | (1,086,822) |
| Increase Liabilities | 344,050 | (193,942) | (846,033) | 3,958 | 1,467,322 |
| Total Expenditures | $9,901,184 | $10,111,579 | $9,601,252 | $11,319,209 | $12,498,553 |
| Net Income | $1,148,922 | $916,244 | $810,744 | $843,522 | $539,795 |

Balance Sheet

| | | | | | |
|---|---|---|---|---|---|
| BALANCE SHEETS | | | | | |
| Assets | | | | | |
| Invested Assets | 36,746,857 | 38,500,027 | 38,439,843 | 39,820,380 | 42,821,003 |
| Other Assets | 14,029,720 | 15,091,437 | 17,005,829 | 18,542,137 | 17,910,825 |
| Total Assets | $50,776,577 | $53,591,464 | $55,445,672 | $58,362,517 | $60,731,828 |
| Liabilities | 35,329,538 | 36,777,159 | 36,268,740 | 37,515,233 | 40,514,371 |
| Other Liabilities incld Debt | 12,913,552 | 13,958,169 | 16,019,145 | 17,458,634 | 16,760,790 |
| Total Liabilities | $48,243,090 | $50,735,328 | $52,287,885 | $54,973,867 | $57,275,161 |
| Equity | 2,533,488 | 2,856,135 | 3,157,786 | 3,388,651 | 3,456,669 |
| Total Liabilities and Equity | $50,776,577 | $53,591,464 | $55,445,672 | $58,362,517 | $60,731,828 |

### Trends, Ratios and Growth Analysis

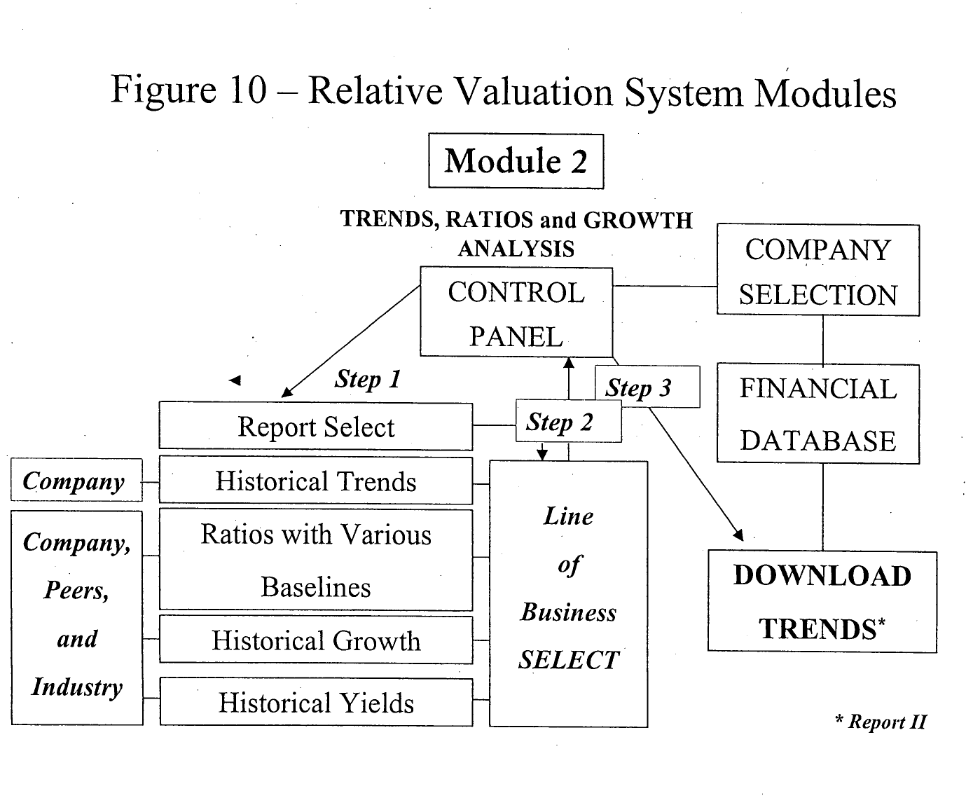

The Trends, Ratios and Growth Analysis module, FIG. 10, of the Relative Valuation System provides sets of reporting tools that enables any user to generate or view a selected company, its peers and the company's industry on several pre-selected basis. With this set of tools user can view (1) historical trends, (“For example, what is the trend for Total Revenue by Line of Business over the last five years for my selected company.”), (2) ratios (“For example, what is the ratio of Expenses over Revenues for all Lines of Business for the last five years—for the company, its peers and the industry.”), and (3) growth rates (“For example what are the Growth Rates in Assets and Liabilities—Prior Year and 4 Year Compounded—for the company, its peers and the industry.”)

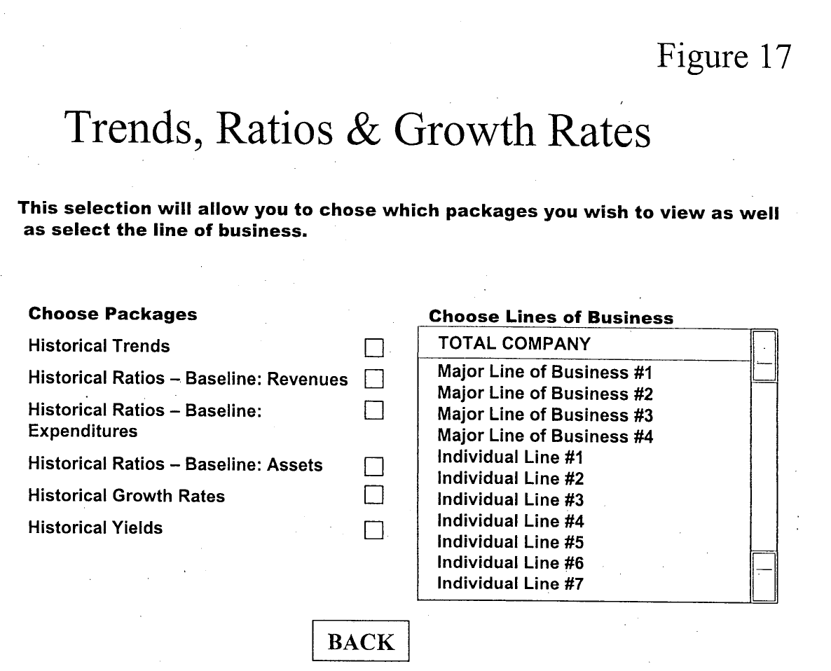

To choose the desired report, user must click the SELECT button next to the Trends, Ratios and Growth Rate Analysis item on the Control Panel. A submenu, as is shown in FIG. 17, would then enables user to choose the type of analysis to be performed

Trends—Within the Trends Analysis reporting tools, the user has the ability to look at, or generate reports for selected companies from a variety of perspectives. These reports enables the recipient to easily and simply view the trends and the performance of single or multiple companies over the latest five years on basic and important metrics, such as—
New Sales
Total Revenue
Cost of Goods Sold
Sales Expenses
General and Administrative Expenses
Net Operating Income

Each of the above Trends is viewable by Total Company, Major Line(s) of Business, or Line(s) of Business. The metrics available vary by industry.

Ratios—This set of Relative Value tools in the analysis process allows a “drill down” view of a company's ratios of performance for a number of Historical Ratios—(1) Revenue, (2) New Sales, (3) Expenditures, (4) Assets, (5) Growth Rates, and (6) Average Invested Assets. Within each of these views, the user can examine the metrics from either Total Company, or Major Line(s) of Business, or Line(s) of Business level.

Growth Rates—The user can also view the growth rates on a year-over-year basis and on a four year compounded basis. The user can view growth rates by selecting any mixture from the several metrics including but not limited to:
Assets
Liabilities
Adjusted Net Worth
Total Revenues
Sale Expenses
General and Administrative Expenses
Total Expenditures
Net Gain from Operations

Peer and Industry Analysis—A unique feature of the Trends, Ratios and Growth Rates module is the peer group and industry results generator. With each set of Ratios and Growth Rates, the Relative Valuation System will automatically generate the same ratios and growth rates for a company's peer group and the company's industry. The Relative Valuation System generates the peer grouping on a dynamic basis for each company selected. If the ratios or growth rates are applicable to the entire company, such as growth in total assets, the peer group for which comparable ratios or growth rate will be provided will be selected as limited number of companies immediately above and below the selected company when ranked by total company revenues. If a ratio or growth rate is applicable to a specific line of business the peer group generated by the system for comparative ratios or growth rates will be selected by size using revenues for that line of business.

Along with the ratios and growth rates for the selected company and its peers, the Relative Valuation System will also automatically provide comparable data for the selected company's industry. The ratio and growth rates used for industry averages are calculated by the system on a weighted basis, reflecting the size of each company.

When a user has finished selecting the Trends, Ratios and Growth Rates reports that user wishes to have produced, the user returns to the menu and then clicks on the “GENERATE” button under the Produce Reports selection area.

Sample reports from the Trends, Ratios and Growth Rate module are shown below in Tables 4, 5, and 6.

TABLE 4
Historical Trends

| | Year t − 5 | Year t − 4 | Year t − 3 | Year t − 2 | Year t − 1 |
|---|---|---|---|---|---|
| Total Revenue | $11,027,823 | $10,411,994 | $12,162,730 | $13,038,346 | $13,524,767 |
| Cost of Sales | 250,341 | 239,371 | 240,696 | 248,872 | 307,005 |
| Administrative Expenses | 608,351 | 565,354 | 628,669 | 748,576 | 600,616 |
| Total Expenditures | 10,207,319 | 9,527,629 | 11,112,460 | 12,328,034 | 12,323,502 |
| Net Gain from Operations | 421,017 | 486,159 | 604,214 | 249,244 | 694,088 |

TABLE 5
Historical Ratios

| | Year t − 5 | Year t − 4 | Year t − 3 | Year t − 2 | Year t − 1 |
|---|---|---|---|---|---|
| SPECIFIED COMPANY | | | | | |
| Sales Expense/Revenues | 2.27% | 2.30% | 1.98% | 1.91% | 2.27% |
| Admin Expenses/Revenue | 5.52% | 5.43% | 5.17% | 5.74% | 4.44% |
| Net Gain/Revenue | 3.82% | 4.67% | 4.97% | 1.91% | 5.13% |
| PEER COMPARISON | | | | | |
| Sales Expense/Revenues | 2.79% | 2.73% | 3.47% | 3.20% | 2.93% |
| Admin Expenses/Revenue | 6.19% | 6.59% | 5.94% | 5.71% | 4.73% |
| Net Gain/Revenue | 3.80% | 3.81% | 2.79% | 3.91% | 3.68% |
| INDUSTRY COMPARISON | | | | | |
| Sales Expense/Revenues | 5.50% | 5.53% | 5.79% | 5.60% | 5.48% |
| Admin Expenses/Revenue | 7.88% | 7.66% | 7.47% | 7.17% | 6.54% |
| Net Gain/Revenue | 5.00% | 5.48% | 4.11% | 4.48% | 4.02% |

TABLE 6
Historical Growth Rates (Year over Year)

| | Average | Year t − 4 | Year t − 3 | Year t − 2 | Year t − 1 |
|---|---|---|---|---|---|
| SPECIFIED COMPANY | | | | | |
| Assets | 4.40% | (.05%) | 3.78% | 7.50% | 6.55% |
| Administrative Expenses | (.32%) | (7.07%) | 11.20% | 19.07% | (19.77%) |
| Net Gain | 13.31% | 15.47% | 24.28% | (58.75%) | 178.48% |
| PEER | | | | | |
| COMPARISON | | | | | |
| Assets | 4.20% | 6.83% | 3.30% | 3.59% | 3.13% |
| Administrative Expenses | 3.76% | 13.29% | 1.19% | 1.25% | (.14%) |
| Net Gain | 10.11% | 6.77% | (17.96%) | 47.70% | 13.63% |
| INDUSTRY COMPARISON | | | | | |
| Assets | (9.44%) | (39.31%) | 3.50% | 3.33% | 3.62% |
| Administrative Expenses | (9.09%) | (40.42%) | 7.03% | 3.56% | 3.16% |
| Net Gain | (9.91%) | (32.94%) | (17.61%) | 17.60% | 1.38% |

### Rankings and Comparative Analysis

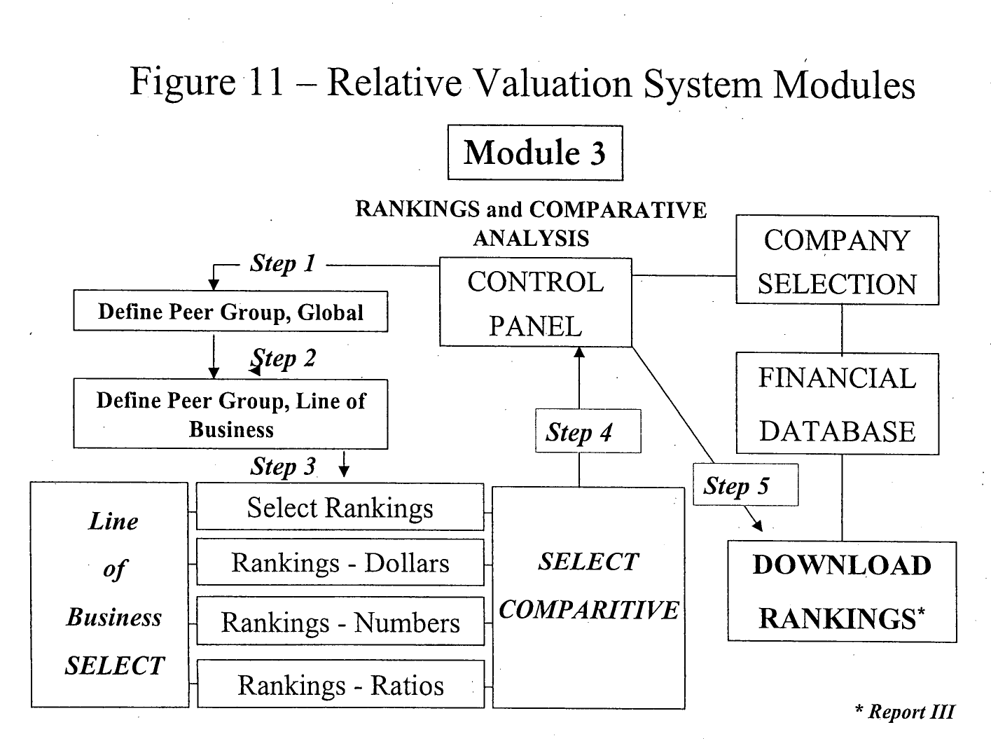

The Rankings and Comparative Analysis module, FIG. 11, of the Relative Valuation System provides sets of reporting tools that enables users to view a company and its peers as part of an industry and not only as a standalone entity. A selected company can have its performance analyzed in light of its historical results within its peer group. The Relative Valuation System has the uniquely advanced capability to create corporate rankings based on a wide range of metrics and then to let user “drill down” in the database to determine the very important “why” of a situation.

Defining a Peer Group

In using the Ranking and Comparative Analysis reports, the user must first define the peer group in which a selected company is to be ranked. To build this peer grouping the Relative Valuation System uses a unique “Intelligent Peer Group Builder”. The Intelligent Peer Group Builder allows the user to create a customized peer group in which the selected company will be ranked using multiple criteria.

For ease, the Relative Valuation System has created two unique methods for defining an intelligent peer group for corporate ranking. The first (and easiest) is Quick Select. If user uses this facility, the user need only select the number of companies the user wants in a peer group, and the selected company become the midpoint of that group. The user then selects what metric the user wants to use for building the intelligent peer group. For example, the choices could be; Assets, Net Worth, or Revenues to name just a few. Once the user has made a selection, by clicking the green SELECT button an intelligent peer group is instantaneously built and user can proceed with the selection of the Rankings reports to be created.

The second and more precise method to define an intelligent peer group is the Advanced Select. With this method the user can build a logical set of criteria for defining a peer group by specify lower and upper boundaries for any number of metrics, including but not limited to: Assets, Adjusted Net Worth, Relative Value, and Revenue.

To assist the user in doing this, the Relative Valuation System displays the actual values of these (Assets, Adjusted Net Worth, Relative Value, and Revenue) metrics for the selected company. The user then can define any lower or upper limits on any of the metrics. Using the defined criteria the Relative Valuation System will instantaneously and intelligently construct the intelligent peer group. After entering a set of numbers, by clicking the SEE UNIVERSE SIZE button, the user can see the number of companies out of the entire universe of companies within the database which fits within the intelligent peer group criteria. The user can then continue to adjust ranges until the user feels comfortable with a final peer group. It should be noted that the system will show user three figures in each universe view—(1) total universe size, (2) number of companies in that category range that fall within the low and high boundaries for that category, and (3) the number of companies that meet the requirements of all the boundary sets. That last figure—the set comprised of the intersection of all the boundary sets—is the universe used.

This intelligent peer builder enables a user to build a relevant peer group in which to rank a selected company. This intelligent peer group construction tool precludes the inclusion of inappropriate companies in rankings and comparisons.

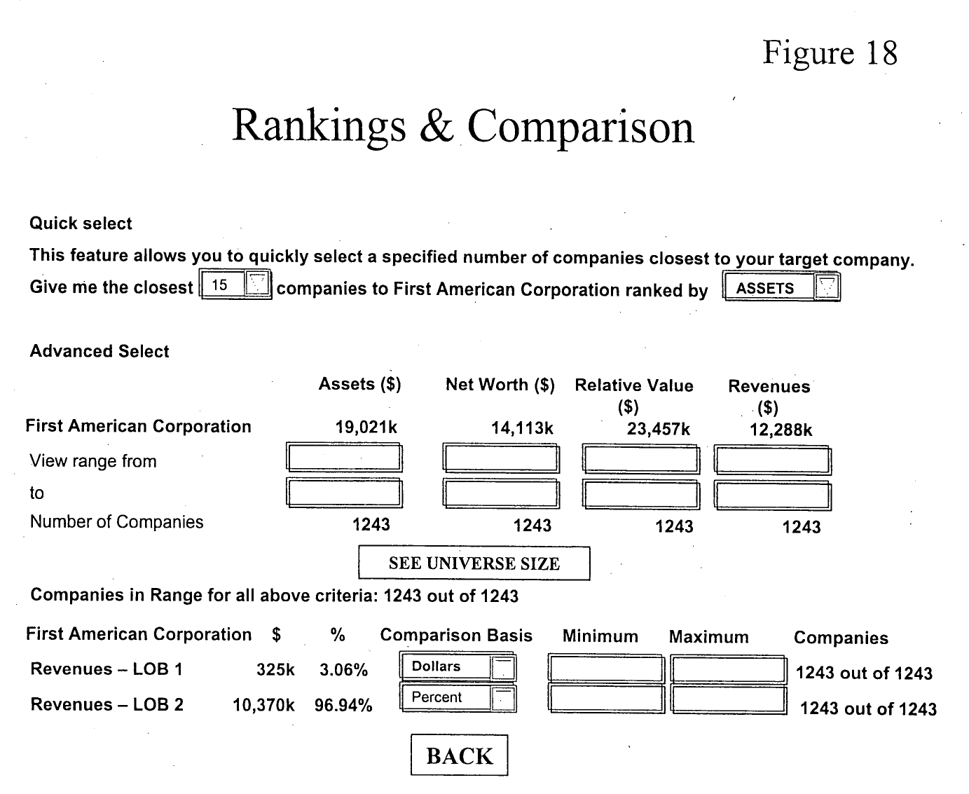

Utilizing a further unique feature of the Intelligent Peer Group builder allows a user to further refine a peer group for Comparative Analysis by setting bandwidth ranges for additional—more finely granular—metrics. This enables a user to more tightly define a true peer by looking at the “where” metrics not just the “how much” metrics. These values can either be expressed in dollars, or as a ratio. In this way a user can rank a company with like-sized companies that generate revenue in similar lines of business. When the user is satisfied with the composition of the intelligent peer group, the system will rank the peer group, including the selected company. The intelligent peer group builder, sample selection criteria are shown in FIG. 18.

After the intelligent peer group is defined, the system can analyze the selected company within its intelligent peer group using any of over 800 distinct rankings. When the user has finished selecting all the Ranking reports that the user wishes to have produced, by clicking the GENERATE button next to Produce Reports on the Rankings Control Panel, the reports will be produced.

Sample outputs from the Rankings and Comparative module are shown below in Table 7, and 8.

TABLE 7
Rankings and Comparatives
Companies with Assets between $5,000,000,000 and $10,000,000,000 and
Equity between $300,000,000 and $500,000,000 ranked by Equity/Assets
(11 companies meeting combined criteria)

| | Equity/ | | |
|---|---|---|---|
| Company | Assets | Assets | Equity |
| National Company | 7.21% | $ 5,702,543,797 | $ 411,278,445 |
| Franklin Company | 7.12% | 5,990,504,163 | 426,641,751 |
| Northern Company | 6.35% | 6,247,271,580 | 396,578,825 |
| Great American | 6.21% | 5,839,873,263 | 362,492,690 |
| Company | | | |
| Security Company | 6.11% | 8,035,776,269 | 491,332,236 |
| American International | 6.00% | 5,974,877,145 | 358,208,824 |
| American Company | 5.79% | 7,066,711,409 | 409,329,030 |
| CAA company | 5.77% | 7,332,388,146 | 422,937,549 |
| Sun Company | 5.72% | 7,218,416,792 | 412,887,493 |
| Transamerican Co | 5.16% | 9,348,434,364 | 482,224,851 |
| American General Co. | 4.32% | 8,502,515,309 | 367,138,030 |

American General Co: = Selected Company

TABLE 8
Rankings and Comparatives
Companies with Assets between $5,000,000,000 and $10,000,000,000 and
Equity between $300,000,000 and $500,000,000 ranked by
Cost of Goods and Services/Revenue
(11 companies meeting combined criteria)
Line of Business “3”

| Company | CGS/Revenue | Assets | Equity |
|---|---|---|---|
| CAA company | 52.49% | $ 7,332,388,146 | $ 422,937,549 |
| American International | 38.60% | 5,974,877,145 | 358,208,824 |
| Franklin Company | 31.98% | 5,990,504,163 | 426,641,751 |
| American General Co. | 30.04% | 8,502,515,309 | 367,138,030 |
| Northern Company | 28.04% | 6,247,271,580 | 396,578,825 |
| National Company | 23.34% | 5,702,543,797 | 411,278,445 |
| Security Company | 23.07% | 8,035,776,269 | 491,332,236 |
| Great American Company | 17.00% | 5,839,873,263 | 362,492,690 |
| Sun Company | 10.90% | 7,218,416,792 | 412,887,493 |
| American Company | 4.86% | 7,066,711,409 | 409,329,030 |
| Transamerican Co | 4.67% | 9,348,434,364 | 482,224,851 |

### Relative Valuation Model

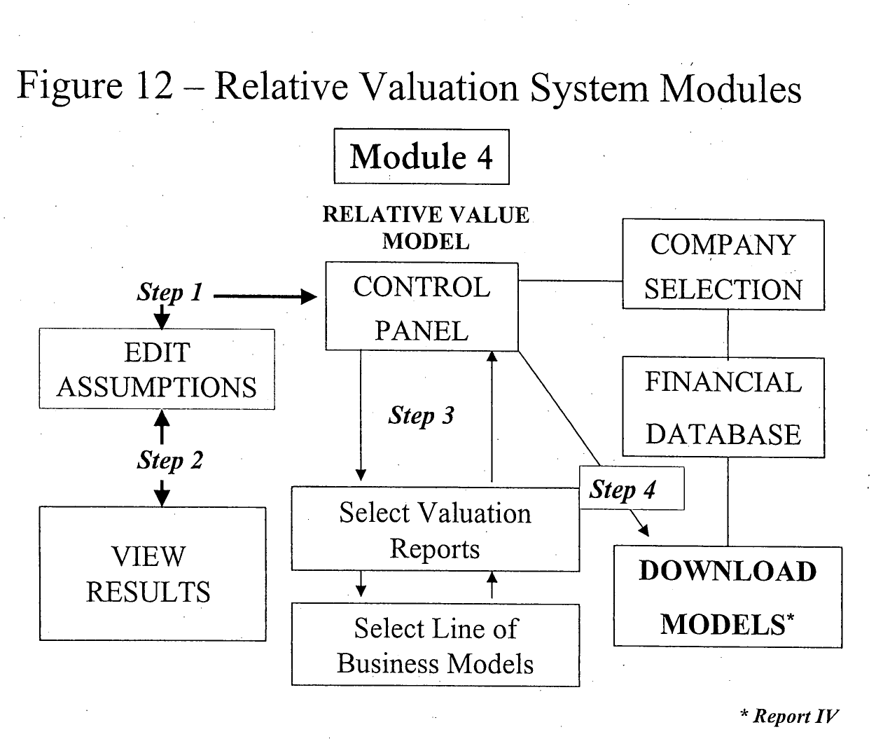

The Relative Valuation System enables the user to perform interactive dynamic modeling of any of the companies in the databases. The Relative Valuation System forecasting, analysis and valuation tools, FIG. 12, enables the user to produce Relative Valuation Models for any entity selected and then optionally roll-up the results into an enterprise level multi-company model.

Traditional financial models often require the establishment of thousands of assumptions for a corporation to be modeled and then those assumptions must be inputted into a software program before any preliminary results can be reviewed. This process can take weeks or months.

The Relative Valuation System utilizes unique data mining techniques to mine a corporation's historical financials, contained within the databases to arrive at the key assumptions that drive a corporations business. Without any user intervention the system establishes preliminary assumptions, based upon the historical financials, and builds a financial model. Assumptions developed by the system, in this manner, are referred to as the “default” assumptions. This unique feature of utilizing default assumptions to pre-build financial forecast makes sophisticated financial forecasting possible even for users non-skilled in the art of forecasting.

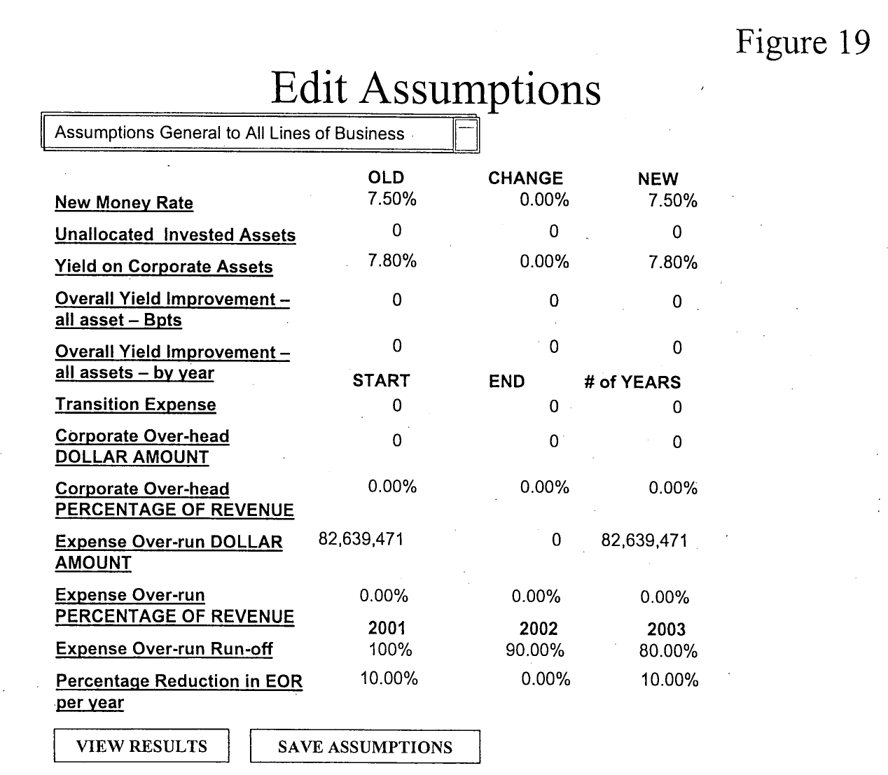

With the Relative Valuation System, within minutes of selecting a company, the user will have preliminary financial models for the selected company produced. These preliminary models are built using the default assumptions derived from the databases. At this point, another unique feature of the system allows the user in conversational mode, to quickly change the default assumptions for the selected company, using the EDIT ASSUMTION page, as is shown in FIG. 19.

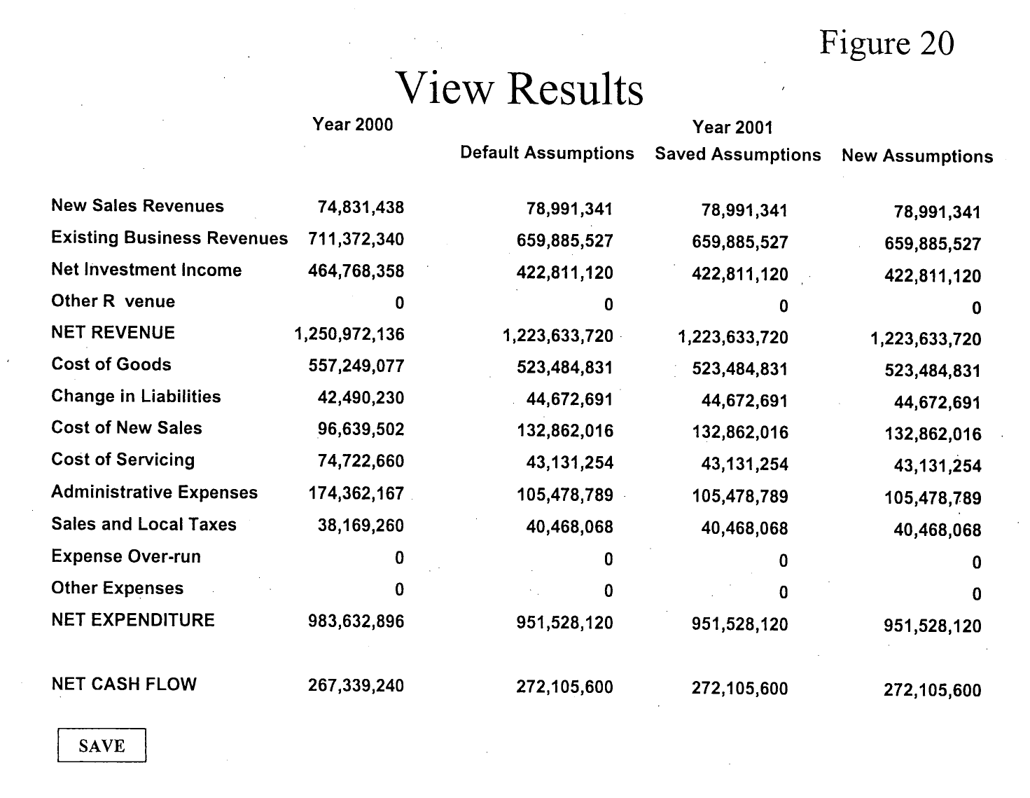

A further unique feature of the system allows the user to view the results from a change in an assumption in VIEW RESULTS window, without requiring the user to download voluminous reports. Editing and changing assumptions in this manner is referred to as “calibrating” the model. The VIEW RESULT calibrating window is shown in FIG. 20.

After a user has finished editing the default assumptions, the user can click on the SELECT button to and download the selected reports.

Two of the distinct reports derived from the Relative Valuation Model are:
1). Relative Valuation Reports
2). Relative Value Models
   Relative Valuation Reports

The Relative Valuation Reports section requires one selection. The user choices are (1) None, (2) Report by: Major Line of Business, or (3) Report by: Individual Line of Business.

A Relative Valuation Report for either the Major Lines of Business or Individual Lines of business can show up to five components of values which would be used to determine the Total Absolute Relative Value of a corporation. These components of value are determined using various discount rates. Shown below in Table 9 is the output from a Relative Valuation Report which includes all of the lines of business for a selected company.

TABLE 9
RELATIVE VALUATION REPORT
VALUE OF BUSINES by Line of Business
(As of December 31, 200t)

| | | | |
|---|---|---|---|
| Adjusted Net Worth | $ 38,207,352 | $ 38,207,352 | $ 38,207,352 |
| COST of CAPITAL After-tax | 4,994,567 | 6,112,556 | 6,852,882 |
| Existing Business: | 8.00% | 10.00% | 12.00% |
| Line of Business 2 | — | | |
| Line of Business 3 | 67,293,132 | 69,669,039 | 70,372,195 |
| Line of Business 4 | 66,623 | 54,636 | 45,678 |
| Line of Business 5 | 218,856 | 187,107 | 162,455 |
| Line of Business 6 | — | — | — |
| Line of Business 7 | 8,054,016 | 6,983,590 | 6,147,584 |
| Line of Business 8 | 4,354 | 3,974 | 3,654 |
| Line of Business 9 | 1,129,917 | 951,898 | 815,850 |
| Line of Business 10 | 2,496 | 2,123 | 1,834 |
| Line of Business 11 | 1,620,622 | 1,410,157 | 1,245,100 |
| Line of Business 12 | — | — | — |
| Federal Income Tax | 27,436,505 | 27,741,883 | 27,578,023 |
| NET EXISTING BUSINESS VALUE | 50,953,509 | 51,520,640 | 51,216,326 |
| New Business: | 10.00% | 12.00% | 0.14% |
| Line of Business 2 | — | | |
| Line of Business 3 | 53,183,944 | 41,387,364 | 32,203,171 |
| Line of Business 4 | — | — | — |
| Line of Business 5 | — | — | — |
| Line of Business 6 | — | — | — |
| Line of Business 7 | (3,967,576) | (3,286,948) | (2,752,825) |
| Line of Business 8 | — | — | — |
| Line of Business 9 | 6,204,870 | 5,172,581 | 4,361,290 |
| Line of Business 10 | — | — | — |
| Line of Business 11 | — | — | — |
| Line of Business 12 | — | — | — |
| Federal Income Tax | 19,397,434 | 15,145,549 | 11,834,073 |
| NET NEW BUSINESS VALUE | 36,023,806 | 28,127,449 | 21,977,564 |
| EXPENSE OVER-RUN After-tax | 73,356,276 | 63,618,116 | 56,661,464 |
| RELATIVE VALUE ADJUSTMENT | 41,672,705 | 37,921,614 | 35,183,616 |
| NET RELATIVE VALUE | 88,506,529 | 86,046,383 | 83,070,512 |

Category I Values. The first component of value above in Table 9 is the “Adjusted Net Worth” of the company. This is used as a proxy for the Category I Value, described under The Relative Value Method.

For certain industries, such as banking, utilities, and insurance there are regulations which place restriction on the capital and other assets which can be taken out of a company without regulatory consent. In order to compensate for the potential non-availability of capital, a cost of capital charge is appropriate. For illustrative purposes Table 9 uses an insurer as the selected company and therefore, a cost of capital charge is shown. The cost of capital charge is an adjustment to the first component of value, the Adjusted Net Worth, or Category I Value.

Category II Values. In businesses such as telecommunication, utilities or insurance, just to name a few, the existing customer bases provide recurring revenue into the future. Using historical financial data the renewal ratios of customers can be determined. Using such renewal ratios the future expected revenues from the existing customer base can be projected. The expenses associated with the servicing of the existing customer can also be projected in a similar manner. From projected revenues and expenses the expected future net cash flows from the existing customer base can be determine. The expected future cash flows can then be discounted back at various discount rates to determine the Category II value, the existing business values.

The value of any corporations existing customer base, the Category II Value, can be determined for any line of business by the following:
EPV_{d,t,c}=(EPV_{d,t+l,c}+EST_{t,c}*v^{-m})*v_{d}
where;
“d” is equal to the discount rate; and
“t” is the year of measurement; and
“c” is the line of business; and
v^{-m}=(1+i)^{m} where, “m ” represents the fraction of the year remaining from the average receipt of cash flows to the end of each calendar year, and “i” represents the interest rate used to discount cash flows, and
   v_{d}=1/(1+i)
EST_{t,c} represents the free cash flows or dividendable profits in year ‘t’ for line of business ‘c,’ with EST_{t,c} being determined by:
   EST_{t,c}=ER_{t,c}+EII_{t,c}+EOR_{t,c}−EB_{t,c}−ES_{t,c}−ECRY_{t,c}−EAD_{t,c}−EOE_{t,c}−EDL_{t,c}
   where;
ER_{0,c} represents the historical core revenue from the existing customer base for line of business ‘c’ in the year prior to the projection period, and where;
   ER_{t,c}=ER_{t-1,c}*(1−rr_{t-1,c}), with;
rr_{t-1,c} being equal to the customer retention rate for line of business ‘c’ in the year t−1.

Within the Relative Valuation System the initial customer retention rate for the last historical measurement year is determined using data mining of historical financials. The system currently sets all future customer retention rates equal to the historical rate for each line of business. These rates can then be changed, as previously described, within the EDIT ASSUMPTION section of the system.

EII_{t,c} represents investment income earned on invested assets associated with line of business ‘c,’ and;

Within the Relative Valuation System the invested assets associated with any line of business are assumed to equal the specific liabilities, if any, associated with that line of business. The assumed yield on assets, in all projection years, is set equal to the historical yield on invested assets as determined for the last historical measurement year. All assumed future yields can be changed within the edit assumption sections of the system.

EOI_{t,c} represents other revenues for line of business ‘c’ in projection year ‘t.’ The other revenue in any future projection year is determined as a constant percentage of the projected core revenue for the line of business or the projected liabilities associate with a line of business, or as a combination of both. The rules within the system are established separately for each industry and each respective line of business and may be changed over time as appropriate based on the historical goodness of fit. Assumptions as to the percentages of projected core revenues or projected liabilities are determined by the system from the historical financial data base.

EB_{t,c} connotes the costs of goods or service provided to existing customers in future years. These costs do not include any sales or marketing costs or any administrative charges. The system examines the historical ratios, through data mining, of the cost of goods and services to core revenues, for each line of business. These ratios are then multiplied by future projected core revenues in order for the system to arrive at the projected future cost of goods and services. The assumption as to the costs of goods and services in all projected years can be modified within the “edit assumptions” section of the system.

ECRY_{t,c} as is calculated in a method similar to the method the system employs to calculate the cost of goods and services in future years, the system also determines, based on historical financial information, the historical relationship between the core revenues for a line of business and the expenses associated with maintaining the relationships with existing customers. The relationships of costs associated with maintaining customer relationships to core revenues are assumed to continue into all future projection years. The assumption as to the costs of maintaining customer relationships in all projected years can be modified within the edit assumptions section of the system.

The administrative expenses which are allocated to a line of business are denoted as EAD_{t,c}. Unlike the cost of goods and services and the cost of maintaining customer relationships, the administrative costs are calculated based upon the historical relationship between the administrative costs and over-head expenses, for an entire industry and for a particular line of business, to the industries total revenues for that line of business. Using such historical relationships the system forecasts the future projected administrative expenses for a company's line of business using that company's projected revenue multiplied by the industry's historical cost factor. In this manner all companies within an industry and line of business have administrative expenses forecast using industry-wide assumptions.

After the administrative and overhead expenses of each company have been forecast by using historical industry factors, the system determines what each company's relationship between revenues to administrative and overhead expenses would have been if the individual company's actual historical experience had been used. The difference between the forecasted administrative expenses based or industry experience and the forecasted administrative expenses bases on company specific expenses is calculated for each line of business and assumed to be that company's “expense over-run.”

Any projected future cash flow which are restricted from distribution are represented by, ‘EDL_{t,c}’ for each line of business ‘c,’ in each future year ‘t.’ This change in the liability for a line of business is determined by the system using a plurality of factors, all determined from the historical experience of the company, applied to revenues, investment income and expenditures, and the prior years liabilities, separately.

Any of the above default assumptions employed by the system can be refined and changed in the future as more historical financial data becomes available.

Category III Value. The fourth component of value shown in the relative valuation report, Table 9, is the value of a corporation infrastructure, or in other words the value of the corporation's ability to produce new sales. The Relative Valuation System, uses the historical financials, develops default assumptions as to a corporation ability to grow new sales and the costs associated with such future new sales. The net projected cash flows from future new sales are then discounted back at various discount rates in order to determine the Category III, infrastructure value.

The value of any corporations' infrastructure value, the Category III Value, is determined for any line of business by first projecting the future cash flows, or distributable income, from the new customer relationships anticipated to be established in the first year of the projections.

NIST_{t,c} represents the free cash flows or dividendable profits in year “t” for line of business “c,” derived from new customer relationships established in year 1. NIST_{t,c} is determined by:
N1ST_{t,c}=N1R_{t,c}+N1II_{t,c}+N1OR_{t,c}−N1B_{t,c}−N1S_{t,c}−N1CFY_{t,c}−N1CRY_{t,c}−N1AD_{t,c}−N1ON1_{t,c}−N1DL_{t,c}
where,

N1R_{0,c} represents the revenues from the new customers for line of business ‘c’ in the year prior to the projection period, and where revenues from new customers in the first year of the projection period can be determined as;
N1R_{1,c}=N1R_{0,c}*(1+gr_{1,c}), with;
gr_{1,c} being equal to the assumed growth in new customer revenue for line of business ‘c’ in the first projection year.

Within the Relative Valuation System the assumed historical growth rate for new customer revenues is calculated using data mining of historical financials and is currently established by the system as the lesser of the prior year growth in new customer revenue, for line of business “c”, or the average of the growth rate for new customer revenue for the average of the five prior years, for line of business “c”. The system currently sets all future growth rates in new customer revenues equal to the historical growth rate as calculated in the manner just described, for each line of business “c”. These default assumptions for new customer revenue growth rates can then be modified within the EDIT ASSUMPTION section of the system.

N1R_{1,c} represents the new customer revenues from new customers in the first projection year. Each year thereafter, these new customers are assumed to continue to generate revenues. The assumed revenues derived from new customers derived in the first projection year in each subsequent projection year is given by:
N1R_{(t>1),c}=N1R_{t-1,c}*(1−rm_{t,c}*rr_{t-1,c}), where;
rr_{t-1,c} is equal to the customer retention rate determined for the core revenues for line of business ‘c’ in the year t−1, and
rm_{t,c} is equal to the retention rate modifier for new business determined for line of business ‘c’ in the year t. The retention rate modifier reflect the assumption that newer customer revenue will be less likely to recur than revenues form long time customers. Within the system the retention rate modifier varies, by line of business between 1 and 2 in the first projection year, and is assumed to equal 1 in all subsequent years.

N1II_{t,c} represents investment income earned on invested assets associated with line of business ‘c,’ and;

Within the Relative Valuation System the invested assets associated with any line of business are assumed to equal the specific liabilities, if any, associated with that line of business. The assumed yield on assets, in all projection years, is assumed equal to a new money yield on invested assets as determined from time to time based upon financial market conditions. All assumed future yields can be changed within the EDIT ASSUMPTION section of the system.

N1OI_{t,c} represents other revenues for line of business ‘c’ in projection year ‘t.’ The other revenue in any future projection year is determined as a constant percentage of the projected core revenue for the line of business or the projected liabilities associate with a line of business, or as a combination of both. The rules within the system are established separately for each industry and each respective line of business and may be changed over time as appropriate based on the historical goodness of fit. Assumptions as to the percentages of projected core revenues or projected liabilities are determined by the system from the historical financial data base.

N1B_{t,c} connotes the costs of goods or service provided to new customers in future years. These costs do not include any sales or marketing costs or any administrative charges. The system examines the historical ratios, through data mining, of the cost of goods and services to core revenues, for each line of business. These ratios are then multiplied by future projected core revenues in order for the system to arrive at the projected future cost of goods and services. The assumption as to the costs of goods and services in all projected years can be modified within the EDIT ASSUMPTION section of the system.

N1CFY_{1,c} is calculated in a method similar to the method the system employs to calculate the cost of goods and services. The system determines, based on historical financial information, the historical relationship between the new customer revenues for a line of business “c” and the sales and marketing expenses associated with developing new customer revenues. After the first year, t=1, N1CFY_{t,c} is assumed to equal zero.

N1CRY_{t,c} is the assumed cost of maintaining a customer relationship after the customer relationship has been established. For new customers the system assumes that cost associated with maintaining customer relationships, as a ratio of revenues are the same as those associated with the existing customer base. Therefore, N1CRY_{t,c} is assumed to equal ECRY_{t,c} in all projection years. The assumption as to the costs of maintaining customer relationships, once a new customer relationship has been established, can be modified within the EDIT ASSUMPTIONS section of the system.

The administrative expenses which are allocated to a line of business are denoted as N1AD_{t,c}. Unlike the cost of goods and services and the cost of maintaining customer relationships, the administrative costs are calculated based upon the historical relationship between the administrative costs and over-head expenses, for an entire industry and for a particular line of business, to the industries total revenues for that line of business. Using such historical relationships the system forecasts the future projected administrative expenses for a company's line of business using that company's projected revenue multiplied by the industry's historical cost factor. In this manner all companies within an industry and line of business have administrative expenses forecast using industry-wide assumptions.

N1OEt_{t,c} represents other expenses for line of business “c” in projection year “t.” The other revenue in any future projection year is determined as a constant percentage of the projected revenue for the line of business or the projected liabilities associate with a line of business, or as a combination of both. The rules within the system are established separately for each industry and each respective line of business and may be changed over time as appropriate based on the fit. Assumptions for the percentages of projected revenues or projected liabilities are determined by the system from the historical financial database.

Any projected future cash flow which are restricted from distribution are represented by, “N1DL_{t,c}” for each line of business “c,” in each future year “t.” This change in the liability for a line of business is determined by the system using a plurality of factors, all determined from the historical experience of the company, applied to revenues, investment income and expenditures, and the prior years liabilities, separately.

Once the Relative Valuation System has developed the future cash flows, or distributable income, from the new customer relationships anticipated to be established in the first year of the projections, the projected future cash flows, or distributable income, from the new customer relationships anticipated to be established in each subsequent year of the can be determined as:
N(f)ST_{t,c}=N(f−1)ST_{t,c}*(1+gr_{f,c})

The total anticipated cash flows, or distributable income, from new customer relationship in any future year “t” is then given by:

$${NST}_{t , c} = {\sum }_{f = l}^{f = t} N ( f ) {ST}_{t + l - f , c} and ;$$

the value of a corporations' infrastructure value, the Category III Value, can be determined for any line of business as:
   NPV_{d,t,c}=(NPV_{d,t+1,c}+NST_{t,c}*v^{-m})*v_{dn}
   where:
“dn” is equal to the discount rate used for Category III Values; and
“t” is the year of measurement; and
“c” is the line of business; and
v^{-m}=(1+iₙ)^{m} where, “m” represents the fraction of the year remaining from the average receipt of cash flows to the end of each calendar year, and “iₙ” represents the interest rate used to discount cash flows from future new customers, and;
   v_{dn}=1/(1+iₙ)

In developing the projected expected future net cash flows for any selected company for both existing customers and from new customers, the Relative Valuation System uses administrative expense assumptions based on industry averages that are derived from the databases. All other assumptions used to determine the Category II and Category III values are developed based on each selected company's historical financials.

The Relative Valuation System also calculates a company's projected administrative expenses for existing customers and new customers using the selected company's historical expense ratios. The excess, if any, of projected expenses using historical expense ratios and the projected expenses using industry average expense ratios, is defined as a company's “expense over-run.” This expense over-run is then projected forward on an assumed run-off basis. The expense over-run shown in Table 9 is the discounted value of the projected expense over-runs, at the various discount rates.

The expense over-runs in each future year after the first, ‘EOR_{t,c}’ are assumed decrease based upon the pricing methodology employed within an industry for the acquisition of a company within such industry. Such assumed run-off rate of the expense over-run may change from time to time based upon prevailing market conditions. The discounted value of the expense over-runs at various discount rates, ‘d,’ are calculated by the system but are not used in the calculation of any company's existing and new business values. The discounted values of the future expense over-runs, ‘PVEOR_{d,t,c}’ are used in the determination of a company's total relative value. The run-off pattern assumed by the system for the expense over-run can be modified within the edit assumption section of the system for both slope and duration.

EOE_{t,c} represents other expenses for line of business ‘c’ in projection year ‘t.’ The other expenses in all future projection years is determined as a constant percentage of the projected core revenue for the line of business or the projected liabilities associate with a line of business, or as a combination of both. The rules within the system are established separately for each industry and each respective line of business and may be changed over time as appropriate based on the fit. Assumptions as to the percentages of projected core revenues or projected liabilities are determined by the system from the historical financial data base.

From the values calculated and shown in Table 9, the Absolute Relative Value of a company can be determined as follows:

$$Absolute Relative Value ( {ARV}_{d , l} ) = \\ \begin{matrix}Adjusted Net Worth ( {ANW}_{l} ) , less \\ Cost of Capital Charge ( {CoC}_{l} ) , plus\end{matrix} \} Category I Values \\ Existing Customer Value ( {EPV}_{d , l} ) , plus \} Category II Value \\ Infra \text{-} structure Value ( {NPV}_{dn , l} ) , less \} Category III Value \\ Expense Over \text{-} runs ( {PVEOR}_{d , l} ) \} Category II and III Values$$

The Absolute Relative Value change from one period to the next is one of the key performance measurements produced by the Relative Valuation System. The Absolute Relative Value as calculated in the manner described above produces the equivalent total value as was described as the Category I, II and III values under the Relative Value Method. While the Absolute Relative Value represents the estimated discounted value of future cash flows from a corporation, assuming performance in the future will be reflective of past performance, it does not necessarily reflect the value a corporation might have as an acquisition candidate.

The Relative Valuation System makes adjustments to Absolute Relative Value in order to determine a corporation's Relative Value. The Relative Value represents a more real-world view of what a corporation might be worth to a potential acquirer. The formulas which are currently used to calculate the Relative Values at the beginning of projection year 1, “RV_{d,l}” are shown below:
ARV_{d,1}=ANWₗ−CoCₗ+EPV_{d,l}+NPV_{dn,l}−PVEOR_{d,l}
RV_{d,l}=ANWₗ+EPV_{d,l}+NPV_{dn,l} (if: EPV_{d,l}>0 and NPV_{dn,l}>0)
RV_{d,l}=ANWₗ+EPV_{d,l}−CoCₗ (if: EPV_{d,l}>0 and NPV_{dn,l}<0 and CoCₗ<−NPV_{dn,l}) and, less 50%*PVEOR_{d,l} (if: EPV_{d,l}−CoCₗ>0 and 50%*PVEOR_{d,l}<EPV_{d,l}−CoCₗ) or, less (EPV_{d,l}−CoCₗ) (if: EPV_{d,l}−CoCₗ>0 and 50%*PVEOR_{d,l}>EPV_{d,l}−CoCₗ)
RV_{d,l}=ANWₗ+EPV_{d,l}−NPV_{dn,l} (if: EPV_{d,l}>0 and NPV_{dn,l}<0 and CoCₗ>−NPV_{dn,l}) and, less 50%* PVEOR_{d,l} (if: EPV_{d,l}−CoCₗ>0 and 50%* PVEOR_{d,l}<EPV_{d,l}−CoCₗ) or, less (EPV_{d,l}−CoCₗ) (if: EPV_{d,l}−CoCₗ>0 and 50%* PVEOR_{d,l}>EPV_{d,l}−CoCₗ)

The formula, shown above, maybe modified from time to time to reflective market conditions.

Relative Value Modeling Reports

The Relative Modeling Reports section enables the user to look at the modeled entity three distinct ways:
(i) separately for future new business to be derived from future new customers;
(ii) recurring business from existing customers;
(iii) and the combined total new and existing.

Within each of these, the user can drill down from a Total Company perspective to a Major Line of business or an Individual Line of Business detail level.

Sample Relative Value Modeling Reports are shown below in Tables 10, 11, and 12.

TABLE 10
Relative Value Model
Existing Business Projections

| INCOME STATEMENTS | Year t | Year t + 1 | Year t + 2 | Year t + 3 | Year t + 4 |
|---|---|---|---|---|---|
| Revenues | 85,277,243 | 70,187,684 | 58,781,321 | 49,978,947 | 43,079,359 |
| Net Investment Income | 15,655,675 | 15,530,648 | 15,370,408 | 15,181,699 | 14,970,164 |
| Other Income | 152,353 | 125,424 | 105,060 | 89,386 | 77,123 |
| Total Revenue | $101,085,271 | $85,843,756 | $74,256,789 | $65,250,032 | $58,126,646 |
| Cost of Goods and Services | 45,809,138 | 40,560,810 | 36,605,114 | 33,524,723 | 31,116,751 |
| Cost of Other Services | 4,504,073 | 5,808,450 | 6,845,391 | 7,634,643 | 8,202,267 |
| Cost of Sales | 3,302,781 | 2,698,671 | 2,244,455 | 1,896,919 | 1,626,694 |
| General Administrative Expenses | 9,562,906 | 7,850,595 | 6,557,841 | 5,564,034 | 4,787,470 |
| Other disbursements | 3,037,044 | 2,586,580 | 2,153,007 | 1,820,710 | 1,562,262 |
| Additional Expenses | 15,371,186 | 13,834,668 | 12,450,661 | 11,205,595 | 10,085,035 |
| Increase in Liabilities | 2,459,990 | 934,556 | (207,733) | (1,072,192) | (1,731,779) |
| Total Expenditures | $84,047,118 | $74,274,330 | $66,648,736 | $60,574,432 | $55,648,700 |
| Net Distributable Gain | $17,038,153 | $11,569,426 | $7,608,053 | $4,675,600 | $2,477,946 |
| Present Value @ 8% | $78,390,014 | $52,251,877 | $31,018,534 | $13,441,303 | ($1,364,587) |
| Present Value @ 10% | $79,262,524 | $54,779,437 | $34,843,888 | $18,269,563 | $4,215,325 |
| Present Value @ 12% | $78,794,351 | $55,840,335 | $37,127,682 | $21,524,290 | $8,226,010 |

TABLE 11
Relative Value Model
New Business Projections

| INCOME STATEMENTS | Year t | Year t + 1 | Year t + 2 | Year t + 3 | Year t + 4 |
|---|---|---|---|---|---|
| Revenues | 24,618,782 | 41,005,933 | 54,157,081 | 64,738,180 | 73,248,993 |
| Net Investment Income | (285,369) | 195,84 | 692,466 | 1,196,701 | 1,703,214 |
| Other Income | 43,370 | 72,123 | 95,183 | 113,679 | 128,519 |
| Total Revenue | $24,376,783 | $41,273,899 | $54,944,730 | $66,048,560 | $75,080,726 |
| Cost of Goods and Services | 4,377,036 | 10,703,421 | 16,213,122 | 21,011,986 | 25,192,099 |
| Cost of Other Services | 0 | 146,655 | 285,708 | 387,393 | 439,410 |
| Cost of Sales | 17,338,360 | 18,002,571 | 18,534,573 | 18,960,683 | 19,301,982 |
| General Administrative Expenses | 9,844,890 | 11,718,307 | 13,222,535 | 14,430,705 | 15,401,424 |
| Other disbursements | 750,569 | 1,255,907 | 1,664,001 | 1,995,440 | 2,264,720 |
| Additional Expenses | 0 | (600) | 0 | 0 | 0 |
| Increase in Liabilities | 2,958,058 | 4,066,065 | 4,848,236 | 5,390,784 | 5,758,153 |
| Total Expenditures | $35,268,913 | $45,892,326 | $54,768,175 | $62,176,991 | $68,357,788 |
| Net Distributable Gain | ($10,892,130) | ($4,618,427) | $176,555 | $3,871,569 | $6,722,938 |
| Present Value @ 10% | $ 55,421,240 | $ 71,855,493 | $ 83,669,468 | $ 91,859,860 | $ 97,174,277 |
| Present Value @ 12% | $ 43,272,998 | $ 59,357,888 | $ 71,109,260 | $ 79,465,816 | $ 85,130,145 |
| Present Value @ 14% | $ 33,811,637 | $ 49,437,396 | $ 60,987,057 | $ 69,348,690 | $ 75,185,938 |

TABLE 12
Relative Value Model
New and Existing Business Projections Combined - does not include NII on Adjusted Net Worth

| INCOME STATEMENTS | Year t | Year t + 1 | Year t + 2 | Year t + 3 | Year t + 4 |
|---|---|---|---|---|---|
| Revenues | 109,896,025 | 111,193,617 | 112,938,402 | 114,717,127 | 116,328,352 |
| Net Investment Income | 15,370,306 | 15,726,491 | 16,062,874 | 16,378,400 | 16,673,378 |
| Other Income | 195,723 | 197,547 | 200,243 | 203,065 | 205,642 |
| Total Revenue | $125,462,054 | $127,127,655 | $129,201,519 | $131,298,592 | $133,207,372 |
| Cost of Goods and Services | 50,186,174 | 51,264,231 | 52,818,236 | 54,536,709 | 56,308,850 |
| Cost of Other Services | 4,504,073 | 5,955,105 | 7,131,099 | 8,022,036 | 8,641,677 |
| Cost of Sales | 20,641,141 | 20,701,242 | 20,779,028 | 20,857,602 | 20,928,676 |
| General Administrative Expenses | 19,407,796 | 19,568,902 | 19,780,376 | 19,994,739 | 20,188,894 |
| Other disbursements | 3,787,613 | 3,842,487 | 3,817,008 | 3,816,150 | 3,826,982 |
| Additional Expenses | 15,371,186 | 13,834,068 | 12,450,661 | 11,205,595 | 10,085,035 |
| Increase in Liabilities | 5,418,048 | 5,000,621 | 4,640,503 | 4,318,592 | 4,026,374 |
| Total Expenditures | $119,316,031 | $120,166,656 | $121,416,911 | $122,751,423 | $124,006,488 |
| Net Distributable Gain | $6,146,023 | $6,950,999 | $7,784,608 | $8,547,169 | $9,200,884 |
| Present Value @ 10% to 12% | $122,535,522 | $114,137,325 | $105,953,148 | $97,735,379 | $89,345,470 |

### Relative Valuations

Relative Valuations of entire sectors and industries have been pre-calculated by the Relative Valuation System through the discounting of projected cash flows for every company represented within a data base utilizing consistently applied standardized assumptions objectively generated from historical data using the Relative Value Method, as described herein. This enables the user to easily and quickly define the parameters for selection of analysis companies and then to analyze those companies with a “Board” ready set of reports.

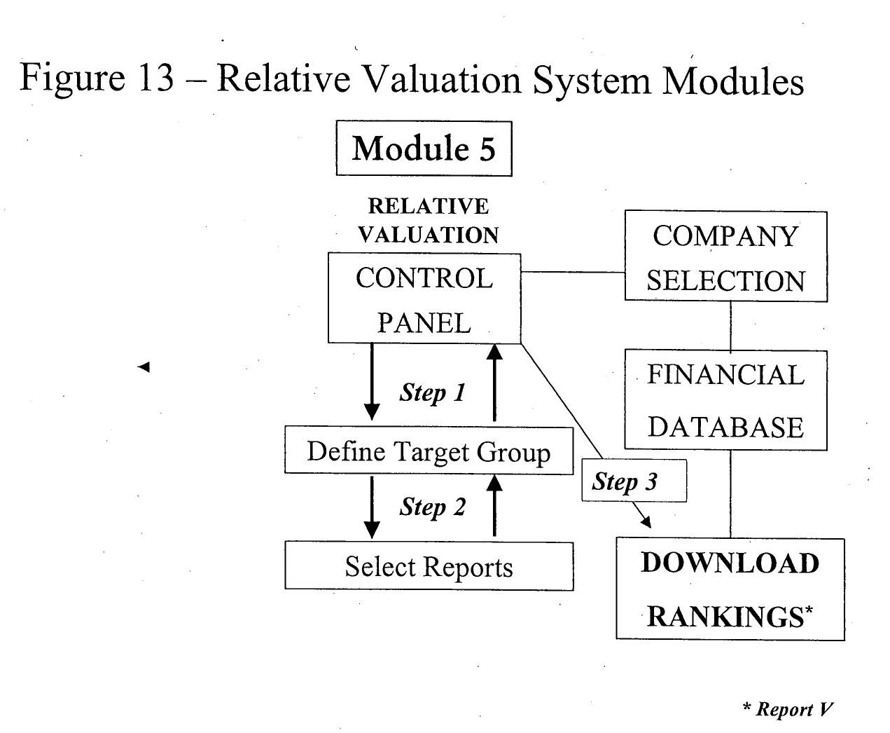

The features included in the Relative Value module, FIG. 13, of the Relative Valuation System allows users to easily fill requests that otherwise would be costly and time prohibitive. The Relative Valuation System enables the user to identify all the companies within a data base within specific valuation metrics. For example, the user could request the system to identify all companies with a Relative Value before expense over-runs of between 50 and 100 million dollars, and within that group further identify all companies with Adjusted Net Worth between 10 and 20 million dollars.

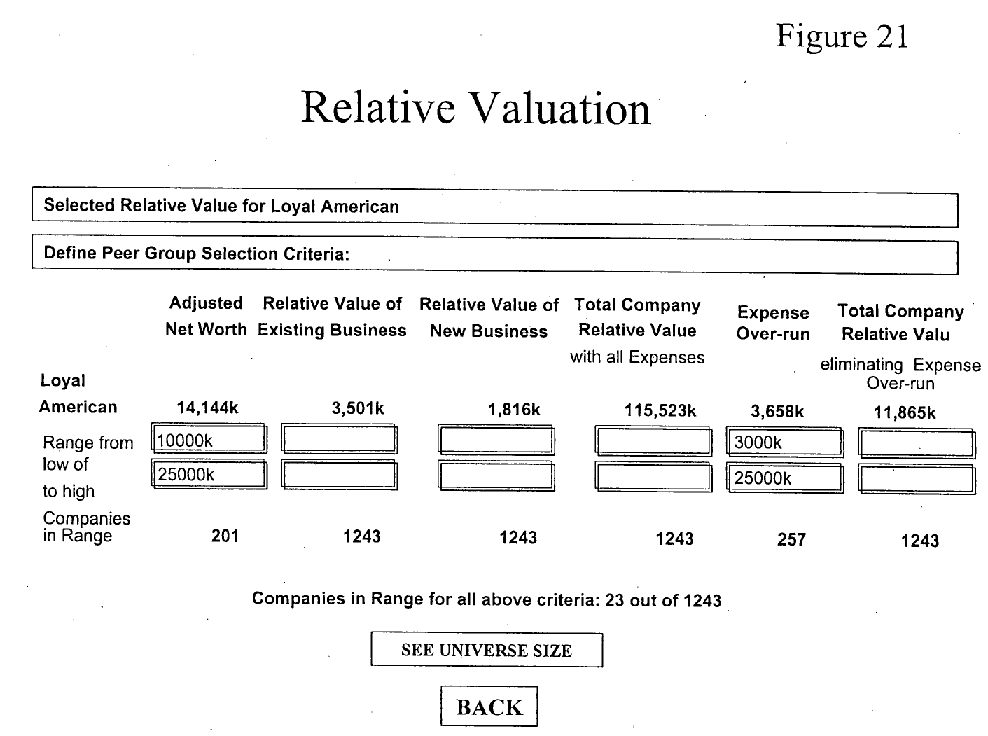

Relative Values uses a precise Advanced Select methodology for peer group construction. This unique method of peer group building enables the user to build a logical set of criteria for defining the peer group by specifying lower and upper boundaries for any number of the following metrics—Adjusted Net Worth, Relative Value of Existing Business, Relative Value of Infra-structure, Total Company Relative Value with all expenses, Expense Over-Run, and Total Company Relative Value Eliminating Expense Overrun. The Relative Value peer group builder selection criteria are shown in FIG. 21.

To assist the user in building a Relative Value peer group, The Relative Valuation System displays the actual values of these metrics for the user from a selected “reference” company. The user can then define the high and low range which The Relative Valuation System will use to instantaneously and intelligently construct the user peer group for the user. The user must simply enter the lower and upper ranges or boundaries for the user proposed peer group. After entering a set of criteria the user can click the SEE UNIVERSE SIZE button to see how many companies out of the entire universe of industry specific companies fits into the user proposed peer group. The user can then continue to adjust the criteria until the user is comfortable with the final peer group. It should be noted that the system will show the user three figures in each universe view—(1) total universe size, (2) number of companies in that category range that fall within the user's low and high boundaries for that criteria, and (3) the number of companies that meet the requirements of all the user criteria. That last set of companies, comprised of the intersection of all the boundary sets, becomes the user's universe. This enables the user to build a valid peer group in which to search for companies that meet the Relative Value parameters which the user has established.

A sample report output showing different Relative Valuation rankings are shown below in Table 13.

TABLE 13
Relative Valuation Rankings
All Companies with Adjusted Net Worth between $500,000,000 and $1,000,000,000 and Existing Business
greater than $500,000,000 and Total Relative Value between $1,100,000,000 and $3,000,000,000
(companies in range 4 of 1243)

| | Total Company | Adjusted Net | Existing | New | Expense | Absolute |
|---|---|---|---|---|---|---|
| Name | Relative Value | Worth | Business | Business | Over-run | Relative Value |
| Protective Company | 2,936,685,902 | 717,740,009 | 2,032,443,005 | 376,620,221 | 380,214,665 | 2,556,471,238 |
| American General Co | 2,073,994,079 | 520,090,803 | 1,572,283,338 | 152,633,659 | 342,027,443 | 1,731,966,637 |
| Bankers Company | 1,883,253,055 | 512,633,563 | 779,127,056 | 607,855,545 | 32,766,217 | 1,850,455,838 |
| Southern Company | 1,432,244,000 | 782,887,310 | 545,719,658 | 121,345,584 | 35,417,103 | 1,396,826,897 |
| | Relative | | | | | |
| | GAAP | | Total | | Total | Distributable |
| Name | Earning × 15 | Total Assets | Liabilities | Equity | Revenues | Cash flow |
| Protective Company | 6,540,370,401 | 6,929,914,621 | 6,303,640,506 | 707,740,009 | 1,383,183,643 | 89,712,292 |
| American General Co | 2,138,412,873 | 8,502,515,309 | 8,135,377,279 | 520,090,803 | 910,257,375 | 437,066,806 |
| Bankers Company | 538,379,390 | 4,960,102,941 | 4,557,795,161 | 512,633,563 | 1,874,828,092 | 170,716,191 |
| Southern Company | 414,670,988 | 6,249,250,253 | 5,588,773,368 | 782,887,310 | 582,870,989 | 122,508,576 |

### Relative GAAP Pro Forma

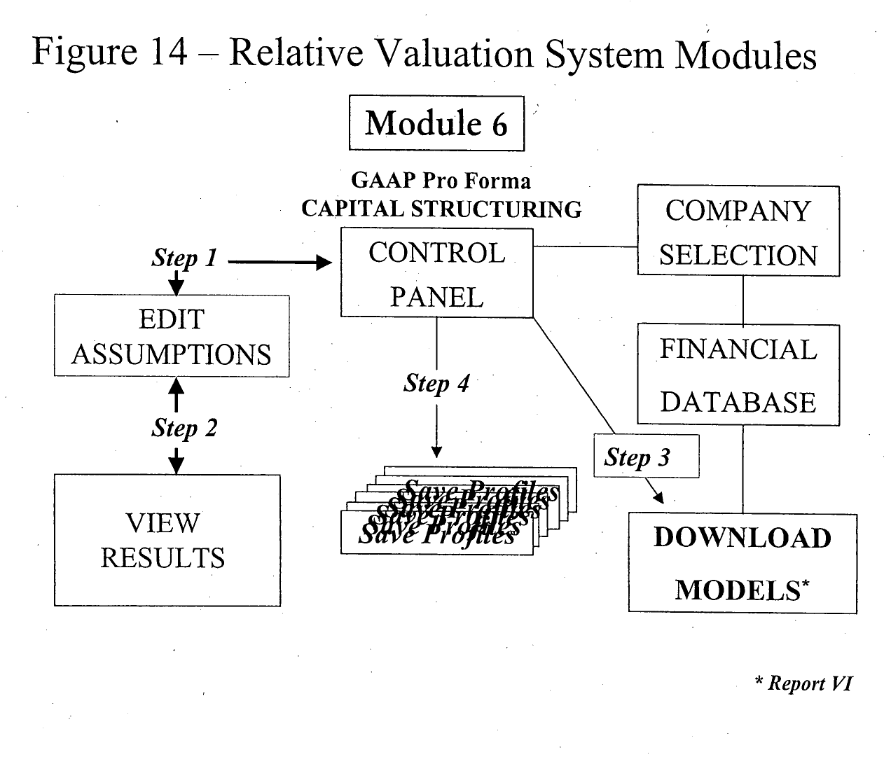

Another unique set of analytical tools available from the Relative Valuation System is the Relative GAAP Pro Forma module, FIG. 14. This aspect of the system allows a user to convert the Relative Valuation Models into Relative GAAP Pro Forma projections. Relative Valuation to GAAP Pro Forma enables a user to easily examine changes and test the assumptions derived by the system to reconcile back to published GAAP results, if available, for a selected company.

The Relative GAAP Pro Forma module is unique in that it allows the user to rebuild an entire industry's' GAAP earning using consistent assumptions and consistent leverage. Similar to the Relative Valuation module the Relative GAAP Pro Forma module uses default assumption, including the assumption that each companies leverage ratio is comprised of 35% debt, 25% senior debt, and 10% subordinated debt utilizing current market rates of interest. In this manner all companies within an industry can be viewed on a relative and consistent basis.

From the user Selected companies the user has the ability to designate (or not) which company should serve as the Parent company into which all the other entities Relative GAAP Pro Forma results will be consolidated. If no Parent is designated, the Relative GAAP Pro Forma results will be specific to each individual entity. Selection of a Parent is simply made by clicking the checkbox next to the appropriate company name.

From the user Selected companies the user has the ability to edit the forecasting and GAAP conversion assumption set created automatically by Relative Valuation System. These assumptions, the “default” assumptions, are in part based upon each company's financial results of the prior five years reported operating results. The user has the ability to easily adjust these assumptions. To change or modify assumptions, the user clicks the EDIT ASSUMPTIONS button and adjusts any of the default assumptions.

Within the GAAP Pro Forma module the user can also test the effect various capital structures changes will have on the future GAAP earnings of a selected company. By default all companies are assumed to have 25% of their capital structure comprised of senior debt and 10% comprised by subordinated debt. Within the EDIT ASSUMPTIONS page, either or both of these leverage ratios can be changed, along with the assumed cost of the debt.

The GAAP Pro Forma module also calculates rates of return on equity, on different exit basis which can by selected by the user, assuming the purchase price of a company is the relative valuation for that company using the average discount rate in the relative valuation module. The user has the ability to change both the assumed purchase price and the exit basis.

If a selected company is designated as the parent company the system will consolidate all other companies together, show the parent designee as a stand alone entity, and then show the total consolidated entity. In this manner the system can perform an accretion dilution analysis for an assumed series of acquisitions or a single acquisition.

Sample Relative GAAP Pro Forma output reports are shown below in Tables 14 and 15.

TABLE 14
Relative GAAP Pro Forma Income

| | Year t | Year t + 1 | Year t + 2 | Year t + 3 | Year t + 4 |
|---|---|---|---|---|---|
| Revenues | 109,896,025 | 111,193,617 | 112,938,402 | 114,717,127 | 116,328,352 |
| Net Investment Income | 17,853,784 | 18,209,969 | 18,546,351 | 18,861,878 | 19,156,856 |
| Other Income | 195,723 | 197,547 | 200,243 | 203,065 | 205,642 |
| Total Revenue | $127,945,532 | $129,601,133 | $131,684,996 | $133,782,070 | $135,690,850 |
| Cost of Goods and Services | 50,186,174 | 51,264,231 | 52,818,236 | 54,536,709 | 56,308,850 |
| Cost of Other Services | 4,504,073 | 5,955,105 | 7,131,099 | 8,022,036 | 8,641,677 |
| Cost of New Sales | 17,338,360 | 17,338,360 | 17,338,360 | 17,338,360 | 17,338,360 |
| Capitalization | (13,870,688) | (13,870,688) | (13,870,688) | (13,870,688) | (13,870,688) |
| Cost of Maintenance | 3,302,781 | 3,362,882 | 3,440,668 | 3,519,242 | 3,590,316 |
| Acquisition Expenses | 7,069,024 | 7,069,024 | 7,069,024 | 7,069,024 | 7,069,024 |
| Capitalization | (5,655,219) | (5,655,219) | (5,655,219) | (5,655,219) | (5,655,219) |
| General Administrative Expenses | 12,338,772 | 12,499,878 | 12,711,352 | 12,925,715 | 13,119,870 |
| Other disbursements | 3,748,744 | 3,673,678 | 3,645,166 | 3,641,247 | 3,649,314 |
| Additional Expenses | 0 | 0 | 0 | 0 | 0 |
| Increase in Liabilities | 5,418,048 | 5,000,621 | 4,640,503 | 4,318,592 | 4,026,374 |
| Interest Expense | 2,387,787 | 2,083,504 | 1,725,144 | 1,308,675 | 834,729 |
| Amortization - VOBA | 0 | 0 | 0 | 0 | 0 |
| DAC | 0 | 1,952,591 | 3,709,922 | 5,291,521 | 6,714,959 |
| Goodwill | 0 | 0 | 0 | 0 | 0 |
| Total Expenditures | $86,767,856 | $90,673,967 | $94,703,567 | $98,445,214 | $101,767,566 |
| GAAP Income before taxes | $41,177,676 | $38,927,166 | $36,981,429 | $35,336,856 | $33,923,284 |
| Tax | 14,412,187 | 13,624,508 | 12,943,500 | 12,367,900 | 11,873,149 |
| GAAP Income after taxes | $26,765,490 | $25,302,658 | $24,037,929 | $22,968,957 | $22,050,135 |

TABLE 15
Relative GAAP Pro Forma Balance Sheets

| | Year t | Year t + 1 | Year t + 2 | Year t + 3 | Year t + 4 |
|---|---|---|---|---|---|
| Invested Assets | 245,686,642 | 264,690,140 | 281,953,146 | 297,652,236 | 311,941,315 |
| Excess Assets @7.25% | 0 | 0 | 0 | 0 | 0 |
| Other Assets | 34,605,255 | 34,605,255 | 34,605,255 | 34,605,255 | 34,605,255 |
| VOBA | 0 | 0 | 0 | 0 | 0 |
| DAC | 19,525,907 | 37,099,224 | 52,915,208 | 67,149,595 | 79,960,543 |
| Goodwill | 49,667,756 | 49,667,756 | 49,667,756 | 49,667,756 | 49,667,756 |
| TOTAL ASSETS | $349,485,560 | $386,062,375 | $419,141,365 | $449,074,842 | $476,174,869 |
| Liabilities | 222,857,158 | 227,857,779 | 232,498,282 | 236,816,874 | 240,843,248 |
| Other Liabilities | 5,646,057 | 5,646,057 | 5,646,057 | 5,646,057 | 5,646,057 |
| Senior Debt @ 7.50% | 17,454,482 | 12,676,349 | 7,123,436 | 804,155 | 0 |
| Subordinated Debt @ 9.00% | 8,604,638 | 8,604,638 | 8,604,638 | 8,604,638 | 2,356,533 |
| Deferred taxes | 12,227,587 | 23,279,255 | 33,232,725 | 42,197,935 | 50,273,713 |
| Shareholder Equity | 82,695,638 | 107,998,297 | 132,036,227 | 155,005,182 | 177,055,318 |
| TOTAL LIABILITIES & | $349,485,560 | $386,062,375 | $419,141,365 | $449,074,841 | $476,174,869 |
| EQUITY | | | | | |
| Exit Valuation #1 | | | | | |
| 12X after-tax GAAP - | 339,810,603 | 319,883,239 | 301,911,278 | 285,835,138 | 271,112,510 |
| before interest | | | | | |
| Outstanding Debt - Senior | 17,454,482 | 12,676,349 | 7,123,436 | 804,155 | 0 |
| Sub Debt and Excess Assets | 8,604,638 | 8,604,638 | 8,604,638 | 8,604,638 | 2,356,533 |
| Net at Exit | $ 313,751,483 | $ 298,602,252 | $ 286,183,204 | $ 276,426,345 | $ 268,755,977 |
| Rate of Return on Equity | 460.97% | 131.06% | 72.32% | 49.10% | 36.88% |
| Exit Valuation #2 | | | | | |
| 8.5X after-tax GAAP - | 227,506,653 | 215,072,604 | 204,322,403 | 195,236,125 | 187,426,150 |
| including interest | | | | | |
| Net at Exit | $227,506,653 | $215,072,604 | $204,322,403 | $195,236,125 | $187,426,150 |
| Rate of Return on Equity | 306.77% | 96.10% | 54.01% | 36.69% | 27.36% |

While this invention has been described with reference to the foregoing preferred embodiments, the scope of the present invention is not limited by the foregoing written description. Rather, the scope of the invention is defined by the following claims and equivalents thereof.

1. A method of determining the value of a corporate enterprise, comprising the steps of:
calculating a Category I Value by determining a corporations' liquidity or adjusted net worth value through elimination of balance sheet assets representing non-liquid or non-marketable assets;
estimating a Category II Value of the corporation that represents future cash flows or distributable earnings from the corporation's existing customer base, by making assumptions as to a likelihood of occurrence of future events;
estimating a Category III value of the corporation that represents the corporation's anticipated future net cash flows or distributable earnings to be derived from new customers which the corporation will likely have in the future, with such estimates being based upon series of assumptions developed based upon historical financial data; and
estimating a Category IV value of the corporation that represents the corporation's potential venture capital value.

2. A method of viewing a corporation from a plurality of bases and perspectives comprising the steps of:
a) accessing a company's historical financial data through databases integrated within the system;
b) viewing key trends, ratios and growth rates for a multiplicity of key historical financial measurements and comparing such financial measurements to identical measurements for a company's peer group, said peer group defined as corporations within the industry with comparable revenue, and also comparing such company against identical financial measurements for its industry on a weight basis;
c) defining an intelligent peer group of comparable companies within an industry with comparability defined by a plurality of criteria including asset size, net worth, revenues, profits, or revenues by line of business and comparing selected financial measurements including a multiplicity of comparative financial analytics;
d) calculating a plurality of values for the corporation on a relative basis against all companies comprising its industry;
e) comparing a corporation's risk profile as determined by the calculation of said values and a risk profile, against a selected set of comparable companies within an industry, with comparability being defined by selected ratios of values for the corporations; and
f) recasting historical financial measurements into financial projects for a corporation on multiple basis including distributable cash flow and Pro Forma GAAP earnings, all using consistently derived assumptions applied to all companies within an industry.

3. The method of claim 2, wherein the risk profile is based on a risk signature defined by a Category I value, representing a liquidity or adjusted net worth value of the corporation, a Category II value, representing future cash flows or distributable earnings from a corporation's existing customer base, a Category III value, representing the corporation's anticipated future net cash flows or distributable earnings to be derived from new customers of which the corporation has a historical demonstrable ability to produce, and a Category IV value, representing the corporation's venture capital value.

4. The method of claim 2, wherein each of said steps a) through e) are performed on an overall company basis.

5. The method of claim 2, wherein each of said steps a) through e) are performed by a specified line of business.

6. The method of claim 2, wherein said peer group includes only those peer companies exhibiting similar characteristics for a multiplicity of financial metrics, including asset, liabilities, revenues, and proportion of business within a line of business or lines of businesses.

7. The method of claim 2, wherein the plurality of values in step d) include adjusted net worth, existing business value, new business value, existing and new business value with and without expense over-runs, relative value, and absolute relative value.

8. The method of claim 7, wherein each company's absolute relative value is adjusted to a relative value by making adjustments based on known market factors, and comprising the steps of:
a) calculating the adjusted net worth, existing business value, and new business value;
b) comparing the new business value to the “expense over-run” value;
c) reducing the new business value by a factor of the “expense over-run” value; and
d) adjusting by cost of capital if the new business value exceeds the “expense over-run” value.

9. A method by which companies within an industry are valued, comprising the steps of:
a) developing a historical expenses assumption for companies within an industry based on both units and revenues, using financial data contained within existing databases;
b) applying industry expense assumptions to each company's projected future revenues and units;
c) calculating each individual company's actual historical expenses based upon financial data contained within the databases;
d) applying individual company expense experience to a first year projected revenues and units;
e) determining a difference between the expenses projected using actual company historical ratios and company expenses projected using industry average expense assumptions;
f) forecasting an excess, if any, of actual expenses over industry average expenses using a forecast run-off pattern; and
g) discounting the projected expenses over-run to the beginning of the projection period using various discount rates.
